(19) United States
(12) Patent Application Publication
(10) Pub. No.: US 2022/0209245 A1
(43) Pub. Date: Jun. 30, 2022

(54) ELECTRODES HAVING CONFORMAL COATINGS DEPOSITED ONTO POROUS ELECTRICAL CURRENT COLLECTORS

(71) Applicant: PPG Industries Ohio, Inc., Cleveland, OH (US)

(72) Inventors: Olivia L. Jones, Cranberry Township, PA (US); Stuart D. Hellring, Pittsburgh, PA (US); Jacob W. Mohin, Pittsburgh, PA (US); Haley L. Orler, Bridgeville, PA (US); Samuel L. Esarey, Allison Park, PA (US)

(73) Assignee: PPG Industries Ohio, Inc., Cleveland, OH (US)

(21) Appl. No.: 17/605,299

(22) PCT Filed: Feb. 25, 2020
(86) PCT No.: PCT/US2020/019651

§ 371 Date: Oct. 21, 2021

Related U.S. Application Data
(60) Provisional application No. 62/839,045, filed on Apr. 26, 2019.

(51) Int. Cl. H01M 4/80; H01M 4/62; H01M 4/04; H01G 11/24; H01G 11/28; H01G 11/86

(52) U.S. Cl. CPC H01M 4/80; H01M 4/623; H01M 4/0457; H01M 2004/021; H01G 11/28; H01G 11/86; H01G 11/24

(57) ABSTRACT

The present invention is directed towards an electrode comprising a porous electrical current collector comprising a surface comprising a plurality of apertures; a conformal coating present on at least a portion of the surface of the porous electrical current collector, the conformal coating comprising an electrochemically active material and an electrodepositable binder. Also disclosed herein are electrical storage devices comprising the electrode, and methods of preparing electrodes.

### NOTICE OF GOVERNMENT SUPPORT

This invention was made with Government support under Government Contract No. DE-EE0007266 awarded by the Department of Energy. The United States Government has certain rights in this invention.

### FIELD OF THE INVENTION

The present invention is directed towards battery electrodes made from porous electrical current collectors, methods of making such electrodes, and electrical storage devices including the same.

### BACKGROUND INFORMATION

There is a trend in the electronics industry to produce smaller devices, powered by smaller and lighter batteries. Batteries with a negative electrode, such as a carbonaceous material, and a positive electrode, such as lithium metal oxides, can provide relatively high power and relatively low weight. Binders for producing such electrodes are usually combined with the negative electrode or positive electrode in the form of a solventborne or waterborne slurry that are applied to electrical current collectors to form an electrode. Once applied, the bound ingredients need to be able to tolerate large volume expansion and contraction during charge and discharge cycles without losing interconnectivity within the electrodes. Interconnectivity of the active ingredients in an electrode is extremely important in battery performance, especially during charging and discharging cycles, as electrons must move through the electrode, and lithium ion mobility requires interconnectivity within the electrode between active particles. However, solventborne slurries present safety, health and environmental dangers because many organic solvents utilized in these slurries are toxic and flammable, volatile in nature, carcinogenic, and involve special manufacturing controls to mitigate risk and reduce environmental pollution. In contrast, waterborne slurries have oftentimes produced unsatisfactory electrodes having poor adhesion and/or poor performance when included in an electrical storage device. Furthermore, conventional methods of applying the solventborne and waterborne slurries to electrical current collectors may be difficult if the electrical current collector is a non-uniform shape and/or composition such as porous electrical current collectors that may reduce the overall weight of the electrode. Improved battery performance is desired, particularly at lower overall weight without the use of carcinogenic materials and environmental pollution.

### SUMMARY OF THE INVENTION

Disclosed herein is an electrode comprising a porous electrical current collector comprising a surface comprising a plurality of apertures; a conformal coating present on at least a portion of the surface of the porous electrical current collector, the conformal coating comprising an electrochemically active material and an electrodepositable binder.

Also disclosed herein is an electrical storage device comprising (a) an electrode comprising a porous electrical current collector comprising a surface comprising a plurality of apertures; a conformal coating present on at least a portion of the surface of the porous electrical current collector, the conformal coating comprising an electrochemically active material and an electrodepositable binder; (b) a counter-electrode; and (c) an electrolyte.

Further disclosed herein are a method of preparing an electrode, the method comprising at least partially immersing a porous electrical current collector comprising a surface comprising a plurality of apertures into a bath comprising an electrodepositable coating composition comprising an electrochemically active material and an electrodepositable binder; electrodepositing a conformal coating deposited from the electrodepositable coating onto a portion of the porous electrical current collector immersed in the bath, wherein the conformal coating comprises the electrochemically active material and the electrodepositable binder.

### BRIEF DESCRIPTION OF THE DRAWINGS

FIG. 1 is an illustration of an exemplary wire mesh having a plurality of apertures on its surface.

FIG. 2 is a cross-sectional view of two adjacent wires from the wire mesh of FIG. 1 having a conformal coating deposited thereon that fills in the aperture between the two wires.

FIG. 3 is the same cross-section view of FIG. 2 with additional grid lines showing the distance between different components of the coated wire mesh.

FIG. 4 is a cross-sectional view of two adjacent wires from the wire mesh of FIG. 1 having a conformal coating deposited thereon that does not fill in the aperture between the two wires.

FIGS. 5A and 5B are optical images of an exemplary electrode of the present invention at 20 um scale.

FIGS. 6A and 6B are optical images of an exemplary electrode of the present invention at 50 um scale. FIG. 6A shows an un-coated portion and edge profile while FIG. 6B shows an entirely coated portion.

FIGS. 7A and 7B are cross-section field emission scanning electron microscopy (FE-SEM) analysis of an exemplary electrode of the present invention coated for a 5 second deposition rate. FIG. 7A is a high magnification (100 um scale) and FIG. 7B is a low magnification (300 um scale).

FIGS. 8A and 8B are cross-section field emission scanning electron microscopy (FE-SEM) analysis of an exemplary electrode of the present invention coated for a 10 second deposition rate. FIG. 8A is a high magnification (100 um scale) and FIG. 8B is a low magnification (300 um scale).

### DETAILED DESCRIPTION OF THE INVENTION

As stated above, the present invention is directed to an electrode comprising a porous electrical current collector comprising a surface comprising a plurality of apertures, and a conformal coating present on at least a portion of the surface of the porous electrical current collector, the conformal coating comprising an electrochemically active material and an electrodepositable binder.

As used herein, the term “conformal coating” refers to a continuous film having a relatively uniform thickness that conforms to the topography and geometry of the underlying substrate. For example, for a porous substrate, the conformal coating will have a relatively uniform appearance and thickness over the surface of the substrate and will map underlying substrate surface. The conformal coating will be described in more detail below.

The porous electrical current collector may comprise any suitable conductive material. For example, the porous electrical current collector may comprise metals, metal alloys, and/or substrates that have been metallized, such as nickel-plated plastic. Additionally, the electrical current collector may comprise non-metal conductive materials including composite materials such as, for example, materials comprising carbon fibers or conductive carbon. The metal or metal alloy may comprise iron, copper, aluminum, nickel, and alloys thereof. For example, the metal or metal alloy may comprise ferrous metals such as cold rolled steel, hot rolled steel, stainless steel, steel coated with zinc metal, zinc compounds, or zinc alloys, such as electrogalvanized steel, hot-dipped galvanized steel, galvanealed steel, and steel plated with zinc alloy; aluminum and/or aluminum alloys of the 1XXX, 2XXX, 3XXX, 4XXX, 5XXX, 6XXX, 7XXX or 8XXX series as well as clad aluminum alloys and cast aluminum alloys of the A356 series; magnesium alloys of the AZ31B, AZ91C, AM60B, or EV31A series; titanium and/or titanium alloys; nickel and/or nickel alloys; and copper and/or copper alloys. Other suitable conductive materials include conductive carbon; non-woven conductive carbon; a material coated with a conductive primer coating; a pre-made battery electrode for preparation of a multi-layered battery electrode; an electrically conductive porous polymer; and a porous polymer comprising a conductive composite. The porous electrical current collector may also comprise a carbon-coated conductive material, such as a carbon-coated porous aluminum or copper material.

The porous electrical current collector may be flexible such that it could be used in a roll-to-roll coating process. For example, the porous electrical current collector may have flexibility similar to that of an aluminum or copper foil.

Although the shape and thickness of the current collector are not particularly limited, the current collector may have a thickness of about 0.5 to 1,000 microns, such as 1 to 500 microns, such as 1 to 400 microns, such as 1 to 300 microns, such as 1 to 250 microns, such as 1 to 200 microns, such as 5 to 100 microns, such as 5 to 75 microns, such as 5 to 50 microns such as 10 to 25 microns.

The porous electrical current collector comprises a surface comprising a plurality of apertures. The apertures may be added to the electrical current collector through mechanical means (e.g., punching apertures into the electrical current collector), may result from the method of manufacture used to make the porous electrical current collector (e.g., woven, non-woven, or mesh electrical current collectors), or may include a combination of each. The apertures can be uniformly or non-uniformly distributed over the surface of the electrical current collector. For example, the apertures may be present as a pattern over the surface of the electrical current collector or may be present in a random arrangement.

The apertures may comprise any shape or combination of shapes. For example, the apertures may be generally round and comprise a circular or oval-like shape(s). Alternatively, the apertures may comprise one or more polygons. The shape of the apertures may be regular or irregular.

The size of the apertures is not particularly limited. The size could be small enough that the conformal coating is able to span the aperture and form a film over the entire void of the aperture, or large enough that the aperture is not filled by the conformal coating. The conformal coating will not deposit and form a film over the entire void of the aperture if the aperture exceeds a certain size. Whether the aperture is filled will depend upon a number of factors, such as, for example, the shape of the aperture, the thickness of the porous electrical current collector, the type of porous electrical current collector selected (e.g., punched, mesh, etc.), the aperture pattern, and the thickness of the deposited coating. For example, if the electrical current collector is a wire mesh, the conformal coating will deposit at a generally uniform thickness over the wires of the mesh. The deposited coating will not fill the aperture if the aperture size exceeds two times the deposited coating thickness because the coating will extend into the aperture from the wires it is formed therefrom. If the aperture exceeds two times the deposited coating thickness, the coating extending from each wire will not meet in the middle of the aperture. For example, am aperture size of 74 microns (assuming a polygon shape) would be filled or closed with a deposited coating film thickness of 37 microns.

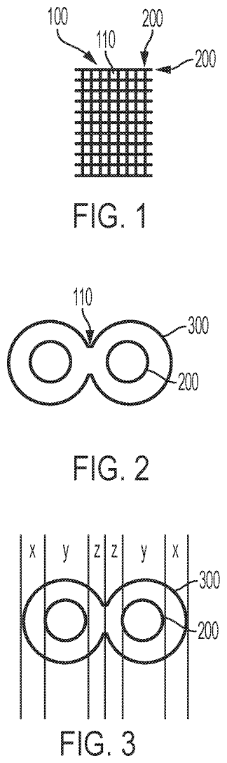

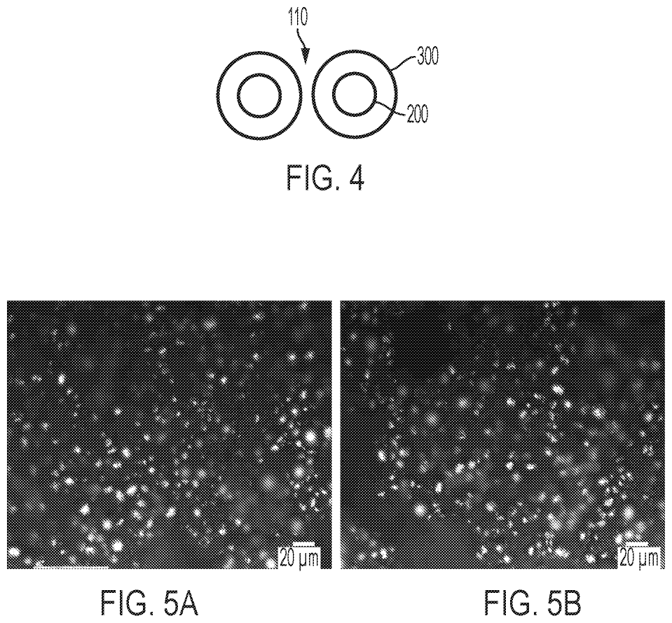

FIG. 1 provides an illustration of an exemplary wire mesh 100 having a plurality of apertures 110 on its surface. FIG. 2 provides a cross-sectional view of two adjacent wires 200 from the mesh and a conformal coating 300 deposited thereon that fills in the aperture 110 between the two wires 200 as the conformal coating 300 extending from each wire 200 meets in the aperture 110. FIG. 3 is the same cross-section view of FIG. 2 with additional grid lines showing the distance between the two wires 200 represented by the two “z” lengths, the thickness of the conformal coating 300 around each wire 200 represented by the “x” segment lengths, and the thickness of the wire 200 represented by the Y segment lengths. In contrast to FIG. 2, FIG. 4 provides a cross-sectional view of two adjacent wires 200 from the mesh and a conformal coating 300 deposited thereon that does not fill in the aperture 110 between the two wires 200 as the conformal coating 300 extending from each wire 200 fails to meet in the aperture 110. As shown in these figures, the conformal coating has a uniform thickness around the metal wire that conforms the coating to the metal wire geometry and reflects the mesh pattern in the coated electrode. This is distinct from non-electrodeposited coatings that apply a coating having uniform thickness and do not retain (or conform to) the shape of the underlying mesh (or other porous electrical current collectors).

The apertures having a generally round shape may have a diameter of 500 microns or less, such as 400 microns or less, such as 250 microns or less, such as 150 microns or less, such as 100 microns or less, such as 90 microns or less, such as 80 microns or less. The generally round apertures may have a diameter of at least 10 microns, such as at least 20 microns, such as at least 40 microns, such as at least 50 microns, such as at least 60 microns, such as at least 70 microns, such as at least 100 microns. The generally round apertures may have a diameter of 10 to 500 microns, such as 10 to 400 microns, such as 10 to 250 microns, such as 10 to 150 microns, such as 10 to 100 microns, such as 10 to 90 microns, such as 10 to 80 microns, such as 20 to 500 microns, such as 20 to 400 microns, such as 20 to 250 microns, such as 20 to 150 microns, such as 20 to 100 microns, such as 20 to 90 microns, such as 20 to 80 microns, such as 40 to 500 microns, such as 40 to 400 microns, such as 40 to 250 microns, such as 40 to 150 microns, such as 40 to 100 microns, such as 40 to 90 microns, such as 40 to 80 microns, such as 50 to 500 microns, such as 50 to 400 microns, such as 50 to 250 microns, such as 50 to 150 microns, such as 50 to 100 microns, such as 50 to 90 microns, such as 50 to 80 microns, such as 60 to 500 microns, such as 60 to 400 microns, such as 60 to 250 microns, such as 60 to 150 microns, such as 60 to 100 microns, such as 60 to 90 microns, such as 60 to 80 microns, such as 70 to 500 microns, such as 70 to 400 microns, such as 70 to 250 microns, such as 70 to 150 microns, such as 70 to 100 microns, such as 70 to 90 microns, such as 70 to 80 microns, such as 100 to 500 microns, such as 100 to 400 microns, such as 100 to 250 microns, such as 100 to 150 microns.

The apertures having a polygon shape may have an average longest dimension of 1,000 microns or less, such as 500 microns or less, such as 400 microns or less, such as 250 microns or less, such as 150 microns or less, such as 100 microns or less, such as 90 microns or less, such as 80 microns or less. The apertures having a polygon shape may have an average longest dimension of at least 10 microns, such as at least 20 microns, such as at least 40 microns, such as at least 50 microns, such as at least 60 microns, such as at least 70 microns, such as at least 100 microns. The apertures having a polygon shape may have an average longest dimension of 10 to 1,000 microns, such as 10 to 500 microns, such as 10 to 400 microns, such as 10 to 250 microns, such as 10 to 150 microns, such as 10 to 100 microns, such as 10 to 90 microns, such as 10 to 80 microns, such as 20 to 1,000 microns, such as 20 to 500 microns, such as 20 to 400 microns, such as 20 to 250 microns, such as 20 to 150 microns, such as 20 to 100 microns, such as 20 to 90 microns, such as 20 to 80 microns, such as 40 to 1,000 microns, such as 40 to 500 microns, such as 40 to 400 microns, such as 40 to 250 microns, such as 40 to 150 microns, such as 40 to 100 microns, such as 40 to 90 microns, such as 40 to 80 microns, such as 50 to 1,000 microns, such as 50 to 500 microns, such as 50 to 400 microns, such as 50 to 250 microns, such as 50 to 150 microns, such as 50 to 100 microns, such as 50 to 90 microns, such as 50 to 80 microns, such as 60 to 1,000 microns, such as 60 to 500 microns, such as 60 to 400 microns, such as 60 to 250 microns, such as 60 to 150 microns, such as 60 to 100 microns, such as 60 to 90 microns, such as 60 to 80 microns, such as 70 to 1,000 microns, such as 70 to 500 microns, such as 70 to 400 microns, such as 70 to 250 microns, such as 70 to 150 microns, such as 70 to 100 microns, such as 70 to 90 microns, such as 70 to 80 microns, such as 100 to 1,000 microns, such as 100 to 500 microns, such as 100 to 400 microns, such as 100 to 250 microns, such as 100 to 150 microns.

The size of the apertures of the porous electrical current collector may also be expressed relative to standard U.S. mesh numbers. A standard U.S. mesh is used to express the particle size distribution of a granular material. The mesh number corresponds to the size of openings present in the mesh filter that allows particles of that size or smaller to pass through. For example, the porous electrical current collector could have a mesh number of 10 having an aperture size of 2,000 microns, a mesh number of 12 having an aperture size of 1,700 microns, a mesh number of 14 having an aperture size of 1,400 microns, a mesh number of 16 having an aperture size of 1,180 microns, a mesh number of 18 having an aperture size of 1,000 microns, a mesh number of 20 having an aperture size of 850 microns, a mesh number of 25 having an aperture size of 710 microns, a mesh number of 30 having an aperture size of 600 microns, a mesh number of 35 having an aperture size of 500 microns, a mesh number of 40 having an aperture size of 425 microns, a mesh number of 45 having an aperture size of 355 microns, a mesh number of 50 having an aperture size of 300 microns, a mesh number of 60 having an aperture size of 250 microns, a mesh number of 70 having an aperture size of 212 microns, a mesh number of 80 having an aperture size of 180 microns, a mesh number of 100 having an aperture size of 150 microns, a mesh number of 120 having an aperture size of 125 microns, a mesh number of 140 having an aperture size of 105 microns, a mesh number of 170 having an aperture size of 90 microns, a mesh number of 200 having an aperture size of 75 microns, a mesh number of 230 having an aperture size of 63 microns, a mesh number of 270 having an aperture size of 53 microns, a mesh number of 325 having an aperture size of 44 microns, a mesh number of 400 having an aperture size of 37 microns, a mesh number of 500 having an aperture size of 25 microns, or larger mesh number having smaller apertures.

The apertures may comprise at least 10% of the surface area of the surface of the electrical current collector, such as at least 20% of the surface area of the surface, such as at least 30% of the surface area. The apertures may comprise no more than 95% of the surface area of the surface of the electrical current collector, such as no more than 85%, such as no more than 75%. The apertures may comprise 10% to 95% of the surface area of the surface of the electrical current collector, such as 20% to 85%, such as 30% to 75%, such as 40% to 60%, such as to 45 to 55%.

The current collector optionally may be pretreated with a pretreatment composition prior to depositing the conformal coating. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The current collector optionally may be coated with a primer coating prior to depositing the conformal coating. The primer coating may comprise a conductive primer coating such as a carbon-based primer. The carbon-based primer may comprise any conductive allotrope of carbon, such as, for example, graphene, acetylene black, carbon nanotubes, graphite, and others, and a binder, such as, for example, conductive inorganic binders, organic polymer-based binders, composites, or combinations thereof.

According to the present invention, the conformal coating is present as a continuous film over the surface of the porous electrical current collector. The film may be present within the apertures such that the continuous film spans the apertures and forms a film therein. The film on the surface of the porous electrical current collector and within the apertures of the current collector may have a relatively uniform thickness, wherein the thickness of the conformal coating film on the surface of the porous electrical current collector and within the apertures is substantially the same. For example, with respect to the thickness of the conformal coating film on the surface of the porous electrical current collector and within the apertures, the thicknesses may be within 50% of each other, such as within in 40%, such as within 30%, such as within 20%, such as within 10%, such as within 5%.

The electrodeposition of the conformal coating allows for coatings to be deposited at precise thicknesses that conform to the porous electrical current collector, and a thickness may be selected so as to fill in some or all of the apertures with the conformal coating. For example, the thickness of the conformal coating formed after electrodeposition may be at least 0.5 micron, such as 1 to 1,000 microns (μm), such as 5 to 750 microns such as 10 to 500 μm, such as 20 to 400 microns such as 25 to 300 microns, such as 50 to 250 μm, such as 75 to 200 μm, such as 100 to 150 microns.

As mentioned above, the conformal coating of the electrode is electrodeposited onto the porous electrical current collector from an electrodepositable coating composition. As used herein, the term “electrodepositable coating composition” refers to a composition that is capable of being deposited onto an electrically conductive substrate under the influence of an applied electrical potential. The electrodepositable coating composition used to produce the conformal coating of the electrode comprises an electrochemically active material and an electrodepositable binder, and the conformal coating derived therefrom comprises the same.

Without intending to be bound by any theory, it is believed that depositing the electrodepositable coating composition by electrodeposition allows for the production of the conformal coating. Typical methods of applying electrode coatings to porous current collectors apply coatings that are not conformal, i.e., coatings that have significantly different thicknesses in the apertures and on the surface of the current collector. For example, a coating applied by a drawdown method on a mesh electrical current collector produces an electrode having a constant thickness of coating and electrode, but the thickness of the coating on the wires of the mesh will be less than and different from the thickness of the coating in the apertures. Specifically, the coating in the apertures will be equal to the thickness of the coating applied to the top and bottom of the wire plus the thickness of the wire itself because no wire is present in the aperture to fill that void. The difference in thickness of the coating on the wire and in the aperture results in variances in areal energy (or charge) density across the coated surface because the charge density will be greater in the apertures where there is a thicker coating and more active material. If the electrode is a positive electrode, this varied charge density across the surface of the electrical current collector also requires that the positive electrode be paired with a higher power negative electrode that can handle the areas of higher charge density despite the fact that not all of the electrode provides that higher charge density, which is disfavored. Electrodepositing a conformal coating results in a coating having a substantially uniform thickness across the current collector and a substantially uniform charge density across the electrode surface.

The conformal coating of the electrode may comprise a cross-linked coating. As used herein, the term “cross-linked coating” refers to a thermoset coating wherein functional groups of the component molecules of the electrodepositable binder have reacted to form covalent bonds that cross-link component molecules of the electrodepositable binder. For example, as described below, the electrodepositable binder may comprise a film-forming polymer and a curing agent, and the functional groups of the film-forming polymer may be reactive with the functional groups of the curing agent such that the functional groups react and form covalent bonds during the curing of the conformal coating. Other components of the electrodepositable binder described below may also have functional groups reactive with functional groups of the crosslinking agent and/or film-forming polymer and may also serve to cross-link the coating. In addition, the conformal coating is also a solid coating whether it is cross-linked or not.

The conformal coating of the electrode may also comprise a thermoplastic coating. As used herein, the term “thermoplastic” refers to a non-thermoset coating wherein the component molecules reversibly associate by intermolecular forces and do not form covalent bonds to cross-link the component molecules of the electrodepositable binder.

The electrochemically active material may comprise a material for use as an active material for a positive electrode such that the formed electrode is a positive electrode. For example, the electrochemically active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include LiO₂, FeF₂ and FeF₃, aluminum, Fe₃O₄, and combinations thereof.

The electrochemically active material may comprise a material for use as an active material for a negative electrode such that the formed electrode is a negative electrode. For example, the electrochemically active material may comprise graphite, lithium titanate (LTO), lithium vanadium phosphate (LVP), silicon compounds, tin, tin compounds, sulfur, sulfur compounds, or a combination thereof.

The electrochemically active material may optionally comprise a protective coating. The protective coating may comprise, for example, metal compounds or complexes such as (i) a metal chalcogen, such as a metal oxide, metal sulfide, or metal sulfate; (ii) a metal pnictogen, such as a metal nitride; (iii) a metal halide, such as a metal fluoride; (iv) a metal oxyhalide, such as a metal oxyflouride; (v) a metal oxynitride; (vi) a metal phosphate; (vi) a metal carbide; (vii) a metal oxycarbide; (viii) a metal carbonitride; (ix) olivine(s); (x) NaSICON structure(s); (xi) polymetallic ionic structure(s); (xii) metal organic structure(s) or complex(es); (xiii) polymetallic organic structure(s) or complex(es); or (xiv) a carbon-based coating such as a metal carbonate. Metals that may be used to form the metal compounds or complexes include: alkali metals; transition metals; lanthanum; silicon; tin; germanium; gallium; aluminum; and indium. The metal may also be compounded with boron and/or carbon. The protective coating may comprise, for example, non-metal compounds or complexes such as (i) a non-metal oxide; (ii) a non-metal nitride; (iii) a non-metal carbonitride; (iv) a non-metal fluoride; (v) a non-metallic organic structures or complexes; (vi) or a non-metal oxyfluoride. For example, the protective coating may comprise titania, alumina, silica, zirconia, or lithium carbonate.

The electrochemically active material may be present in the electrodepositable coating composition and conformal coating formed therefrom in amount of at least 45% by weight, such as at least 70% by weight, such as at least 80% by weight, such as at least 90% by weight, such as at least 91% by weight, and may be present in an amount of no more than % by weight, such as no more than 99% by weight, such as no more than 98% by weight, such as no more than 95% by weight, based on the total solids weight of the electrodepositable composition or conformal coating. The electrochemically active material may be present in the electrodepositable coating composition and conformal coating formed therefrom in amount of 45% to 99% by weight, such as 55 to 98% by weight, such as 65% to 98% by weight, such as 70% to 98% by weight, such as 80% to 98% by weight, such as 90% to 98% by weight, such as 91% to 98% by weight, such as 91% to 95% by weight, such as 94% to 98% by weight, such as 95% to 98% by weight, such as 96% to 98% by weight, based on the total solids weight of the electrodepositable coating composition or conformal coating.

As noted above, the electrodepositable coating composition further comprises an electrodepositable binder. The electrodepositable binder serves to bind together particles of the electrodepositable coating composition, such as the electrochemically active material and other optional materials, upon electrodeposition of the coating composition onto a substrate. As used herein, the term “electrodepositable binder” refers to binders that are capable of being deposited onto a conductive substrate by the process of electrodeposition. The electrodepositable binder may comprise a film-forming polymer and may optionally further comprise a curing agent that reacts with the film-forming polymer to cure to the electrodeposited coating composition, in addition to other optional components. The electrodepositable binder is not particularly limited so long as the electrodepositable binder is capable of being deposited onto a conductive substrate by the process of electrodeposition, and a suitable electrodepositable binder may be selected according to the type of electrical storage device of interest.

The film-forming resin of the electrodepositable binder may comprise an ionic film-forming resin. As used herein, the term “ionic film-forming resin” refers to any film-forming resin that carries a charge, including resins that carry a negatively charged (anionic) ion and resins that carry a positively charged (cationic) ion. Suitable ionic resins include, therefore, anionic resins and cationic resins. As will be understood by those skilled in the art, anionic resins are typically employed in anionic electrodepositable coating compositions where the substrate to be coated serves as the anode in the electrodepositable bath and cationic resins are typically employed in cationic electrodepositable coating compositions where the substrate to be coated serves as the cathode in the electrodepositable bath. As described in more detail below, the ionic resin may comprise salt groups comprising the ionic groups of the resin such that the anionic or cationic resins comprise anionic salt group-containing or cationic salt group-containing resins, respectively. Non-limiting examples of resins that are suitable for use as the ionic film-forming resin in the present invention include alkyd resins, acrylics, methacrylics, polyepoxides, polyamides, polyurethanes, polyureas, polyethers, and polyesters, among others.

The ionic film-forming resin may optionally comprise active hydrogen functional groups. As used herein, the term “active hydrogen functional groups” refers to those groups that are reactive with isocyanates as determined by the Zerewitinoff test described in the JOURNAL OF THE AMERICAN CHEMICAL SOCIETY, Vol. 49, page 3181 (1927), and include, for example, hydroxyl groups, primary or secondary amino groups, carboxylic acid groups, and thiol groups.

As discussed above, the ionic resin may comprise an anionic salt group-containing resin. Suitable anionic resins include resins comprise anionic groups, such as acid groups, such as carboxylic acid groups or phosphorous acid groups, which impart a negative charge that may be at least partially neutralized with a base to form the anionic salt group-containing resin. An anionic salt group-containing resin that comprises active hydrogen functional groups may be referred to as an active hydrogen-containing, anionic salt group-containing resin.

The electrodepositable binder may comprise an ionic cellulose derivative, such as an anionic cellulose derivative. Non-limiting examples of anionic cellulose derivatives includes carboxymethylcellulose and salts thereof (CMC). CMC is a cellulosic ether in which a portion of the hydroxyl groups on the anhydroglucose rings are substituted with carboxymethyl groups. Non-limiting examples of anionic cellulose derivatives include those described in U.S. Pat. No. 9,150,736, at col. 4, line 20 through col. 5, line 3, the cited portion of which is incorporated herein by reference.

Examples of (meth)acrylic polymers are those which are prepared by polymerizing mixtures of (meth)acrylic monomers. The anionic (meth)acrylic polymer may comprise carboxylic acid moieties that are introduced into the polymer from the use of (meth)acrylic carboxylic acids. Non-limiting examples of suitable anionic (meth)acrylic polymers include those described in U.S. Pat. No. 9,870,844, at col. 3, line 37 through col. 6, line 67, the cited portion of which is incorporated herein by reference.

Non-limiting examples of other anionic resins that are suitable for use in the compositions described herein include those described in U.S. Pat. No. 9,150,736, at col. 5, lines 4-41, the cited portion of which is incorporated herein by reference.

As mentioned above, in adapting an anionic resin to be solubilized or dispersed in an aqueous medium, it is often at least partially neutralized with a base. Suitable bases include both organic and inorganic bases. Non-limiting examples of suitable bases include ammonia, monoalkylamines, dialkylamines, or trialkylamines such as ethylamine, propylamine, dimethylamine, dibutylamine and cyclohexylamine; monoalkanolamine, dialkanolamine or trialkanolamine such as ethanolamine, diethanolamine, triethanolamine, propanolamine, isopropanolamine, diisopropanolamine, dimethylethanolamine and diethylethanolamine; morpholine, e.g., N-methylmorpholine or N-ethylmorpholine. Non-limiting examples of suitable inorganic bases include the hydroxide, carbonate, bicarbonate, and acetate bases of alkali or alkaline metals, specific examples of which include potassium hydroxide, lithium hydroxide, and sodium hydroxide. The resin(s) may be at least partially neutralized from 20 to 200 percent, such as 40 to 150 percent, such as 60 to 120 percent of theoretical neutralization, based upon the total number of anionic groups present in the resin.

As discussed above, the ionic resin may comprise a cationic salt group-containing resin. Suitable cationic salt-group containing resins include resins that contain cationic groups, such as sulfonium groups and cationic amine groups, which impart a positive charge that may be at least partially neutralized with an acid to form the cationic salt group-containing resin. A cationic salt group-containing resin that comprises active hydrogen functional groups may be referred to as an active hydrogen-containing, cationic salt group-containing resin.

Non-limiting examples of cationic resins that are suitable for use in the compositions described herein include those described in U.S. Pat. No. 9,150,736, at col. 6, line 29 through col. 8, line 21, the cited portion of which is incorporated herein by reference.

As will be appreciated, in adapting the cationic resin to be solubilized or dispersed in an aqueous medium, the resin may be at least partially neutralized by, for example, treating with an acid. Non-limiting examples of suitable acids are inorganic acids, such as phosphoric acid and sulfamic acid, as well as organic acids, such as, acetic acid and lactic acid, among others. Besides acids, salts such as dimethylhydroxyethylammonium dihydrogenphosphate and ammonium dihydrogenphosphate can be used. The cationic resin may be neutralized to the extent of at least 50% or, in some cases, at least 70%, of the total theoretical neutralization equivalent of the cationic polymer based on the total number of cationic groups. The step of solubilization or dispersion may be accomplished by combining the neutralized or partially neutralized resin with the aqueous medium.

The electrodepositable binder may optionally comprise a pH-dependent rheology modifier. The pH-dependent rheology modifier may comprise a portion of or all of the film-forming polymer and/or electrodepositable binder. As used herein, the term “pH-dependent rheology modifier” refers to an organic compound, such as a molecule, oligomer or polymer, that has a variable rheological effect based upon the pH of the composition. The pH-dependent rheology modifier may affect the viscosity of the composition on the principle of significant volume changes of the pH-dependent rheology modifier induced by changes in the pH of the composition. For example, the pH-dependent rheology modifier may be soluble at a pH range and provide certain rheological properties and may be insoluble and coalesce at a critical pH value (and above or below based upon the type of pH-dependent rheology modifier) which causes a reduction in the viscosity of the composition due to a reduction in the volume of the rheology modifier. The relationship between the pH of the composition and viscosity due to the presence of the pH-dependent rheology modifier may be non-linear. The pH-dependent rheology modifier may comprise an alkali-swellable rheology modifier or an acid swellable rheology modifier, depending upon the type of electrodeposition that the electrodepositable coating composition is to be employed. For example, alkali-swellable rheology modifiers may be used for anionic electrodeposition, whereas acid swellable rheology modifiers may be used for cathodic electrodeposition.

The use of the pH-dependent rheology modifier in the electrodepositable binder in the amounts herein may allow for the production of electrodes by electrodeposition. The pH-dependent rheology modifier may comprise ionic groups and/or ionic salt groups, but such groups are not required. Without intending to be bound by any theory, it is believed that the pH dependence of the rheology modifier assists in the electrodeposition of the electrodepositable coating composition because the significant difference in pH of the electrodeposition bath at the surface of the substrate to be coated relative to the remainder of the electrodeposition bath causes the pH-dependent rheology modifier to undergo a significant reduction in volume at, or in close proximity to, the surface of the substrate to be coated inducing coalescence of the pH-dependent rheology modifier, along with the other components of the electrodepositable coating composition, on the surface of the substrate to be coated. For example, the pH at the surface of the anode in anodic electrodeposition is significantly reduced relative to the remainder of the electrodeposition bath. Likewise, the pH at the surface cathode in cathodic electrodeposition is significantly higher than the rest of the electrodeposition bath. The difference in pH at the surface of the electrode to be coated during electrodeposition relative to the electrodeposition bath in a static state may be at least 6 units, such as at least 7 units, such as at least 8 units.

As used herein, the term “alkali-swellable rheology modifier” refers to a rheology modifier that increases the viscosity of a composition (i.e., thickens the composition) as the pH of the composition increases. The alkali-swellable rheology modifier may increase viscosity at a pH of about 2.5 or greater, such as about 3 or greater, such as about 3.5 or greater, such as about 4 or greater, such as about 4.5 or greater, such as about 5 or greater.

Non-limiting examples of alkali-swellable rheology modifiers include alkali-swellable emulsions (ASE), hydrophobically modified alkali-swellable emulsions (HASE), star polymers, and other materials that provide pH-triggered rheological changes at low pH, such as the pH values described herein. The alkali-swellable rheology modifiers may comprise addition polymers having constitutional units comprising the residue of ethylenically unsaturated monomers. For example, the alkali-swellable rheology modifiers may comprise addition polymers having constitutional units comprising, consisting essentially of, or consisting of the residue of: (a) 2 to 70% by weight of a monoethylenically unsaturated carboxylic acid, such as 20 to 70% by weight, such as 25 to 55% by weight, such as 35 to 55% by weight, such as 40 to 50% by weight, such as 45 to 50% by weight; (b) 20 to 80% by weight of a C₁ to C₆ alkyl (meth)acrylate, such as 35 to 65% by weight, such as 40 to 60% by weight, such as 40 to 50% by weight, such as 45 to 50% by weight; and at least one of (c) 0 to 3% by weight of a crosslinking monomer, such as 0.1 to 3% by weight, such as 0.1 to 2% by weight; and/or (d) 0 to 60% by weight of a monoethylenically unsaturated alkyl alkoxylate monomer, such as 0.5 to 60% by weight, such as 10 to 50% by weight, the % by weight being based on the total weight of the addition polymer. The ASE rheology modifiers may comprise (a) and (b) and may optionally further comprise (c), and the HASE rheology modifiers may comprise (a), (b) and (d), and may optionally further comprise (c). When (c) is present, the pH-dependent rheology modifier may be referred to as a crosslinked pH-dependent rheology modifier. When the acid groups have a high degree of protonation (i.e., are un-neutralized) at low pH, the rheology modifier is insoluble in water and does not thicken the composition, whereas when the acid is substantially deprotonated (i.e., substantially neutralized) at higher pH values, the rheology modifier becomes soluble or dispersible (such as micelles or microgels) and thickens the composition.

The (a) monoethylenically unsaturated carboxylic acid may comprise a C₃ to C₈ monoethylenically unsaturated carboxylic acid such as acrylic acid, methacrylic acid, and the like, as well as combinations thereof.

The (b) C₁ to C₈ alkyl (meth)acrylate may comprise a C₁ to C₆ alkyl (meth)acrylate, such as a C₁ to C₄ alkyl (meth)acrylate. The C₁ to C₈ alkyl (meth)acrylate may comprise a non-substituted C₁ to C₈ alkyl (meth)acrylate such as, for example, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isopentyl (meth)acrylate, hexyl (meth)acrylate, heptyl (meth)acrylate, isoheptyl (meth)acrylate, 2-ethylhexyl (meth)acrylate, or combinations thereof.

The (c) crosslinking monomer may comprise a polyethylenically unsaturated monomer such as ethylene glycol di(meth)acrylate, 1,6-hexanediol di(meth)acrylate, divinylbenzene, trimethylolpropane diallyl ether, tetraallyl pentaerythritol, triallyl pentaerythritol, diallyl pentaerythritol, diallyl phthalate, triallyl cyanurate, bisphenol A diallyl ether, methylene bisacrylamide, allyl sucroses, and the like, as well as combinations thereof.

The (d) monoethylenically unsaturated alkylated ethoxylate monomer may comprise a monomer having a polymerizable group, a hydrophobic group and a bivalent polyether group of a poly(alkylene oxide) chain, such as a poly(ethylene oxide) chain having about 5-150 ethylene oxide units, such as 6-10 ethylene oxide units, and optionally 0-5 propylene oxide units. The hydrophobic group is typically an alkyl group having 6-22 carbon atoms (such as a dodecyl group) or an alkaryl group having 8-22 carbon atoms (such as octyl phenol). The bivalent polyether group typically links the hydrophobic group to the polymerizable group. Examples of the bivalent polyether group linking group and hydrophobic group are a bicycloheptyl-polyether group, a bicycloheptenyl-polyether group or a branched C₅-C₅₀ alkyl-polyether group, wherein the bicycloheptyl-polyether or bicycloheptenyl-polyether group may optionally be substituted on one or more ring carbon atoms by one or two C₁-C₆ alkyl groups per carbon atom.

In addition to the monomers described above, the pH-dependent rheology modifier may comprise other ethylenically unsaturated monomers. Examples thereof include substituted alkyl (meth)acrylate monomers substituted with functional groups such as hydroxyl, amino, amide, glycidyl, thiol, and other functional groups; alkyl (meth)acrylate monomers containing fluorine; aromatic vinyl monomers; and the like. Alternatively, the pH-dependent rheology modifier may be substantially free, essentially free, or completely free of such monomers. As used herein, a pH-dependent rheology modifier is substantially free or essentially free of a monomer when constitutional units of that monomer are present, if at all, in an amount of less than 0.1% by weight or less than 0.01% by weight, respectively, based on the total weight of the pH-dependent rheology modifier.

The pH-dependent rheology modifier may be substantially free, essentially free, or completely free of amide, glycidyl or hydroxyl functional groups. As used herein, a pH-dependent rheology modifier if substantially free or essentially free of amide, glycidyl or hydroxyl functional groups if such groups are present, if at all, in an amount of less than 1% or less than 0.1% based on the total number of functional groups present in the pH-dependent rheology modifier.

The pH-dependent rheology modifier may comprise, consist essentially of, or consist of constitutional units of the residue of methacrylic acid, ethyl acrylate and a crosslinking monomer, present in the amounts described above.

The pH-dependent rheology modifier may comprise, consist essentially of, or consist of constitutional units of the residue of methacrylic acid, ethyl acrylate and a monoethylenically unsaturated alkyl alkoxylate monomer, present in the amounts described above.

The pH-dependent rheology modifier may comprise, consist essentially of, or consist of methacrylic acid, ethyl acrylate, a crosslinking monomer and a monoethylenically unsaturated alkyl alkoxylate monomer, present in the amounts described above.

Commercially available pH-dependent rheology modifiers include alkali-swellable emulsions such as ACRYSOL ASE-60, hydrophobically modified alkali-swellable emulsions such as ACRYSOL HASE TT-615, and ACRYSOL DR-180 HASE, each of which are available from the Dow Chemical Company, and star polymers, including those produced by atom transfer radical polymerization, such as fracASSIST® prototype 2 from ATRP Solutions.

Exemplary viscosity data showing the impact of the alkali-swellable rheology modifier across a range of pH values of a composition was obtained for some non-limiting examples of alkali-swellable rheology modifiers using a Brookfield viscometer operated at 20 RPMs and using a #4 spindle. The alkali-swellable rheology modifiers ACRYSOL ASE-60, ACRYSOL HASE TT-615, and ACRYSOL DR-180 HASE were characterized at 4.25% solids in a solution of deionized water. A star polymer (fracASSIST® prototype 2) was investigated at 0.81% solids due to the limited solubility of the polymer at low pH. The pH was adjusted through the addition of dimethyl ethanolamine (“DMEA”). The viscosity measurements in centipoise (cps) across the range of pH values is provided below in Table 1.

TABLE 1

| Rheology | ACRYSOL | | ACRYSOL | | fracASSIST ® | | ACRYSOL | |
|---|---|---|---|---|---|---|---|---|
| Modifier | ASE-60 | | HASE-TT-615 | | prototype 2 | | DR-180 HASE | |
| Property | pH | Viscosity | pH | Viscosity | pH | Viscosity | pH | Viscosity |
| | 3.53 | 0 | 4.24 | 0 | 4.04 | 0 | 4.30 | 0 |
| | 6.31 | 2,010 | 5.90 | 454 | 6.09 | 2,274 | 6.10 | 90 |
| | 6.43 | 19,280 | 6.40 | 15,600 | 7.23 | 2,352 | 6.20 | 11,160 |
| | 6.77 | 19,130 | 7.04 | Off-scale | 7.68 | 1,914 | 7.13 | Off-scale |
| | 7.42 | 17,760 | — | — | 8.72 | 1,590 | — | — |

As shown in Table 1, a composition of water and an alkali-swellable rheology modifier at 4.25% by weight of the total composition may have an increase in viscosity of at least 500 cps over an increase in pH value of 3 pH units within the pH range of 3 to 12, such as an increase of at least 1,000 cps, such as an increase of at least 2,000 cps, such as an increase of at least 3,000 cps, such as an increase of at least 5,000 cps, such as an increase of at least 7,000 cps, such as an increase of at least 8,000 cps, such as an increase of at least 9,000 cps, such as an increase of at least 10,000 cps, such as an increase of at least 12,000 cps, such as an increase of at least 14,000 cps, or more. For example, as shown for the ACRYSOL ASE-60 alkali-swellable rheology modifier in Table 1, an increase in pH from about 3.5 to about 6.5 results in an increase in the viscosity of the composition of about 19,000 cps. A composition of water and an alkali-swellable rheology modifier at 4.25% by weight of the total composition may result in a corresponding decrease in the viscosity of the composition over a corresponding decrease in pH value.

As shown in Table 1, a 4.25% by weight solution of the alkali-swellable rheology modifier, the % by weight based on the total weight of the solution, may have a viscosity increase of at least 1,000 cps when measured from about pH 4 to about pH 7, such as at least 1,500 cps, such as at least 1,900 cps, such as at least 5,000 cps, such as at least 10,000 cps, such as at least 15,000 cps, such as at least 17,000 cps, as measured using a Brookfield viscometer using a #4 spindle and operated at 20 RPMs. A composition of water and an alkali-swellable rheology modifier at 4.25% by weight of the total composition may result in a corresponding decrease in the viscosity of the composition over a corresponding decrease in pH value.

As shown in Table 1, a 4.25% by weight solution of the alkali-swellable rheology modifier, the % by weight based on the total weight of the solution, may have a viscosity increase of at least 1,000 cps when measured from about pH 4 to about pH 6.5, such as at least 1,500 cps, such as at least 1,900 cps, such as at least 5,000 cps, such as at least 10,000 cps, such as at least 15,000 cps, such as at least 17,000 cps, as measured using a Brookfield viscometer using a #4 spindle and operated at 20 RPMs. A composition of water and an alkali-swellable rheology modifier at 4.25% by weight of the total composition may result in a corresponding decrease in the viscosity of the composition over a corresponding decrease in pH value.

As shown in Table 1, a composition of water and an alkali-swellable rheology modifier of an star polymer at 0.81% by weight of the total composition may have a viscosity increase of at least 400 cps when measured from about pH 4 to about pH 6.5, such as at least 600 cps, such as at least 800 cps, such as at least 1,000 cps, such as at least 1,200 cps, such as at least 1,400 cps, such as at least 2,000 cps, such as at least 2,200 cps, as measured using a Brookfield viscometer using a #4 spindle and operated at 20 RPMs.

As used herein, the term “star polymer” refers to branched polymers with a general structure consisting of several (three or more) linear chains connected to a central core. The core of the polymer can be an atom, molecule, or macromolecule; the chains, or “arms”, may include variable-length organic chains. Star-shaped polymers in which the arms are all equivalent in length and structure are considered homogeneous, and ones with variable lengths and structures are considered heterogeneous. The star polymer may comprise any functional groups that enable the star polymer to provide pH-dependent rheology modification.

As used herein, the term “acid-swellable rheology modifier” refers to a rheology modifier that is insoluble at high pH and does not thicken the composition and is soluble at lower pH and thickens the composition. The acid-swellable rheology modifier may increase viscosity at a pH of about 4 or less, such as about 4.5 or less, such as about 5 or less, such as about 6 or less.

The pH-dependent rheology modifier may be present in the electrodepositable binder in an amount of at least 10% by weight, such as at least 20% by weight, such as at least 30% by weight, such as at least 40%, such as at least 50%, such as at least 60%, such as at least 70%, such as at least 75%, such as at least 80%, such as at least 85%, such as at least 90%, such as at least 93%, such as at least 95%, such as 100%, and may be present in an amount of no more than 100% by weight, such as no more than 99% by weight, such as no more than 95% by weight, such as no more than 93% by weight, based on the total solids weight of the binder solids. The pH-dependent rheology modifier may be present in the electrodepositable binder in an amount of 10% to 100% by weight, such as 20% to 100% by weight, such as 30% to 100% by weight, 40% to 100% by weight, 50% to 100% by weight, 60% to 100% by weight, 70% to 100% by weight, 75% to 100% by weight, 80% to 100% by weight, 85% to 100% by weight, 90% to 100% by weight, 93% to 100% by weight, 95% to 100% by weight, such as 50% to 99% by weight, such as 75% to 95% by weight, such as 87% to 93% by weight, based on the total solids weight of the binder solids.

The pH-dependent rheology modifier may be present in the electrodepositable coating composition in an amount of at least 0.1% by weight, such as at least 0.2% by weight, such as at least 0.3% by weight, such as at least 1% by weight, such as at least 1.5% by weight, such as at least 2% by weight, and may be present in an amount of no more than 10% by weight, such as no more than 5% by weight, such as no more than 4.5% by weight, such as no more than 4% by weight, such as no more than 3% by weight, such as no more than 2% by weight, such as no more than 1% by weight, based on the total solids weight of the electrodepositable coating composition. The pH-dependent rheology modifier may be present in the electrodepositable coating composition in an amount of 0.1% to 10% by weight, such as 0.2% to 10% by weight, such as 0.3 to 10% by weight, such as 1% to 7% by weight, such as 1.5% to 5% by weight, such as 2% to 4.5% by weight, such as 3% to 4% by weight, based on the total solids weight of the electrodepositable coating composition.

According to the present invention, the electrodepositable binder may optionally further comprise a fluoropolymer. The fluoropolymer may comprise a portion of the electrodepositable binder of the electrodepositable coating composition. The fluoropolymer may be present in the electrodepositable coating composition in the form of micelles.

The fluoropolymer may comprise a (co)polymer comprising the residue of vinylidene fluoride. A non-limiting example of a (co)polymer comprising the residue of vinylidene fluoride is a polyvinylidene fluoride polymer (PVDF). As used herein, the “polyvinylidene fluoride polymer” includes homopolymers, copolymers, such as binary copolymers, and terpolymers, including high molecular weight homopolymers, copolymers, and terpolymers. Such (co)polymers include those containing at least 50 mole percent, such as at least 75 mole %, and at least 80 mole %, and at least 85 mole % of the residue of vinylidene fluoride (also known as vinylidene difluoride). The vinylidene fluoride monomer may be copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether and any other monomer that would readily copolymerize with vinylidene fluoride in order to produce the fluoropolymer of the present invention. The fluoropolymer may also comprise a PVDF homopolymer.

The fluoropolymer may comprise a high molecular weight PVDF having a weight average molecular weight of at least 50,000 g/mol, such as at least 100,000 g/mol, and may range from 50,000 g/mol to 1,500,000 g/mol, such as 100,000 g/mol to 1,000,000 g/mol. PVDF is commercially available, e.g., from Arkema under the trademark KYNAR, from Solvay under the trademark HYLAR, and from Inner Mongolia 3F Wanhao Fluorochemical Co., Ltd.

The fluoropolymer may comprise a (co)polymer comprising the residue of tetrafluoroethylene. The fluoropolymer may also comprise a polytetrafluoroethylene (PTFE) homopolymer.

The fluoropolymer may comprise a nanoparticle. As used herein, the term “nanoparticle” refers to particles having a particle size of less than 1,000 nm. The fluoropolymer may have a particle size of at least 50 nm, such as at least 100 nm, such as at least 250 nm, such as at least 300 nm, and may be no more than 999 nm, such as no more than 600 nm, such as no more than 450 nm, such as no more than 400 nm, such as no more than 300 nm, such as no more than 200 nm. The fluoropolymer nanoparticles may have a particle size of 50 nm to 999 nm, such as 100 nm to 800 nm, such as 100 nm to 600 nm, such as 250 nm to 450 nm, such as 300 nm to 400 nm, such as 100 nm to 400 nm, such as 100 nm to 300 nm, such as 100 nm to 200 nm. Although the fluoropolymer may comprise a nanoparticle, larger particles and combinations of nanoparticles and larger particles may also be used. As used herein, the term “particle size” refers to average diameter of the fluoropolymer particles. The particle size referred to in the present disclosure was determined by the following procedure: A sample was prepared by dispersing the fluoropolymer onto a segment of carbon tape that was attached to an aluminum scanning electron microscope (SEM) stub. Excess particles were blown off the carbon tape with compressed air. The sample was then sputter coated with Au/Pd for 20 seconds and was then analyzed in a Quanta 250 FEG SEM (field emission gun scanning electron microscope) under high vacuum. The accelerating voltage was set to 20.00 kV and the spot size was set to 3.0. Images were collected from three different areas on the prepared sample, and ImageJ software was used to measure the diameter of 10 fluoropolymer particles from each area for a total of 30 particle size measurements that were averaged together to determine the average particle size.

The fluoropolymer may be present in the electrodepositable binder in an amount of at least 15% by weight, such as at least 30% by weight, such as at least 40% by weight, such as at least 50% by weight, such as at least 70% by weight, such as at least 80% by weight, and may be present in an amount of no more than 99% by weight, such as no more than 96% by weight, such as no more than 95% by weight, such as no more than 90% by weight, such as no more than 80%, such as no more than 70%, such as no more than 60%, based on the total weight of the binder solids. The fluoropolymer may be present in in the electrodepositable binder in amounts of 15% to 99% by weight, such as 30% to 96% by weight, such as 40% to 95% by weight, such as 50% to 90% by weight, such as 70% to 90% by weight, such as 80% to 90% by weight, such as 50% to 80% by weight, such as 50% to 70% by weight, such as 50% to 60% by weight, based on the total weight of the binder solids.

The fluoropolymer may be present in the electrodepositable coating composition in an amount of at least 0.1% by weight, such as at least 1% by weight, such as at least 1.3% by weight, such as at least 1.9% by weight, and may be present in an amount of no more than 10% by weight, such as no more than 6% by weight, such as no more than 4.5% by weight, such as no more than 2.9% by weight, based on the total solids weight of the electrodepositable composition. The fluoropolymer may be present in the electrodepositable coating composition in an amount of 0.1% to 10% by weight, such as 1% to 6% by weight, such as 1.3% to 4.5% by weight, such as 1.9% to 2.9% by weight, based on the total solids weight of the electrodepositable coating composition.

The fluoropolymer to pH-dependent rheology modifier weight ratio may be at least 1:20, such as at least 1:2, such as at least 1:1, such as at least 3:1, such as at least 4:1, such as at least 6:1, such as at least 10:1, such as at least 15:1, such as at least 19:1, and may be no more than 20:1, such as no more than 15:1, such as no more than 10:1, such as no more than 6:1, such as no more than 4:1, such as no more than 3:1, such as no more than 1:1, such as no more than 1:2, such as no more than 1:3. The fluoropolymer to pH-dependent rheology modifier weight ratio may be from 1:20 to 20:1, such as 1:2 to 15:1, such as 1:1 to 10:1, such as 2:1 to 8:1, such as 3:1 to 6:1.

Alternatively, the electrodepositable coating composition may be substantially free, essentially free, or completely free of fluoropolymer. As used herein, the electrodepositable coating composition is substantially free or essentially free of fluoropolymer when fluoropolymer is present, if at all, in an amount of less than 5% by weight or less than 0.2% by weight, respectively, based on the total weight of the binder solids.

The electrodepositable binder may optionally further comprise a dispersant. The dispersant may assist in dispersing the fluoropolymer, the electrochemically active material, and/or, as described further below, the electrically conductive agent (if present) in the aqueous medium. The dispersant may comprise at least one phase that is compatible with the fluoropolymer and/or other components of the electrodepositable coating composition, such as the electrochemically active material or, if present, the electrically conductive agent and may further comprise at least one phase that is compatible with the aqueous medium. The electrodepositable coating composition may comprise one, two, three, four or more different dispersants, and each dispersant may assist in dispersing a different component of the electrodepositable coating composition. The dispersant may comprise any material having phases compatible with both a component of the solids (e.g., the electrodepositable binder, such as the fluoropolymer (if present), the electrochemically active material, and/or the electrically conductive agent) and the aqueous medium. As used herein, the term “compatible” means the ability of a material to form a blend with other materials that is and will remain substantially homogenous over time. For example, the dispersant may comprise a polymer comprising such phases. The dispersant and the fluoropolymer, if present, may not be bound by a covalent bond. The dispersant may be present in the electrodepositable coating composition in the form of a micelle. The dispersant may be in the form of a block polymer, a random polymer, or a gradient polymer, wherein the different phases of the dispersant are present in the different blocks of the polymer, are randomly included throughout the polymer, or are progressively more or less densely present along the polymer backbone, respectively. The dispersant may comprise any suitable polymer to serve this purpose. For example, the polymer may comprise addition polymers produced by polymerizing ethylenically unsaturated monomers, polyepoxide polymers, polyamide polymers, polyurethane polymers, polyurea polymers, polyether polymers, polyacid polymers, and polyester polymers, among others. The dispersant may also serve as an additional component of the electrodepositable binder of the electrodepositable coating composition.

The dispersant may comprise functional groups. The functional groups may comprise, for example, active hydrogen functional groups, heterocyclic groups, and combinations thereof. As used herein, the term “heterocyclic group” refers to a cyclic group containing at least two different elements in its ring such as a cyclic moiety having at least one atom in addition to carbon in the ring structure, such as, for example, oxygen, nitrogen or sulfur. Non-limiting examples of heterocylic groups include epoxides, lactams and lactones. In addition, when epoxide functional groups are present on the addition polymer, the epoxide functional groups on the dispersant may be post-reacted with a beta-hydroxy functional acid. Non-limiting examples of beta-hydroxy functional acids include citric acid, tartaric acid, and/or an aromatic acid, such as 3-hydroxy-2-naphthoic acid. The ring opening reaction of the epoxide functional group will yield hydroxyl functional groups on the dispersant.

When acid functional groups are present, the dispersant may have a theoretical acid equivalent weight of at least 350 g/acid equivalent, such as at least 878 g/acid equivalent, such as at least 1,757 g/acid equivalent, and may be no more than 17,570 g/acid equivalent, such as no more than 12,000 g/acid equivalent, such as no more than 7,000 g/acid equivalent. The dispersant may have a theoretical acid equivalent weight of 350 to 17,570 g/acid equivalent, such as 878 to 12,000 g/acid equivalent, such as 1,757 to 7,000 g/acid equivalent.

As mentioned above, the dispersant may comprise an addition polymer. The addition polymer may be derived from, and comprise constitutional units comprising the residue of, one or more alpha, beta-ethylenically unsaturated monomers, such as those discussed below, and may be prepared by polymerizing a reaction mixture of such monomers. The mixture of monomers may comprise one or more active hydrogen group-containing ethylenically unsaturated monomers. The reaction mixture may also comprise ethylenically unsaturated monomers comprising a heterocyclic group. As used herein, an ethylenically unsaturated monomer comprising a heterocyclic group refers to a monomer having at least one alpha, beta ethylenic unsaturated group and at least cyclic moiety having at least one atom in addition to carbon in the ring structure, such as, for example, oxygen, nitrogen or sulfur. Non-limiting examples of ethylenically unsaturated monomers comprising a heterocyclic group include epoxy functional ethylenically unsaturated monomers, vinyl pyrrolidone and vinyl caprolactam, among others. The reaction mixture may additionally comprise other ethylenically unsaturated monomers such as alkyl esters of (meth)acrylic acid and others described below.

The addition polymer may comprise a (meth)acrylic polymer that comprises constitutional units comprising the residue of one or more (meth)acrylic monomers. The (meth)acrylic polymer may be prepared by polymerizing a reaction mixture of alpha, beta-ethylenically unsaturated monomers that comprise one or more (meth)acrylic monomers and optionally other ethylenically unsaturated monomers. As used herein, the term “(meth)acrylic monomer” refers to acrylic acid, methacrylic acid, and monomers derived therefrom, including alkyl esters of acrylic acid and methacrylic acid, and the like. As used herein, the term “(meth)acrylic polymer” refers to a polymer derived from or comprising constitutional units comprising the residue of one or more (meth)acrylic monomers. The mixture of monomers may comprise one or more active hydrogen group-containing (meth)acrylic monomers, ethylenically unsaturated monomers comprising a heterocyclic group, and other ethylenically unsaturated monomers. The (meth)acrylic polymer may also be prepared with an epoxy functional ethylenically unsaturated monomer such as glycidyl methacrylate in the reaction mixture, and epoxy functional groups on the resulting polymer may be post-reacted with a beta-hydroxy functional acid such as citric acid, tartaric acid, and/or 3-hydroxy-2-naphthoic acid to yield hydroxyl functional groups on the (meth)acrylic polymer.

The addition polymer may comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 1% by weight, such as at least 2% by weight, such as at least 5% by weight, and may be no more than 50% by weight, such as no more than 20% by weight, such as no more than 10% by weight, such as no more than 5% by weight, based on the total weight of the addition polymer. The constitutional units comprising the residue of the alpha, beta-ethylenically unsaturated carboxylic acids may comprise 1% to 50% by weight, 2% to 50% by weight, such as 2% to 20% by weight, such as 2% to 10% by weight, such as 2% to 5% by weight, such as 1% to 5% by weight, based on the total weight of the addition polymer. The addition polymer may be derived from a reaction mixture comprising the alpha, beta-ethylenically unsaturated carboxylic acids in an amount of 1% to 50% by weight, 2% to 50% by weight, such as 2% to 20% by weight, such as 2% to 10% by weight, such as 2% to 5% by weight, such as 1% to 5% by weight, based on the total weight of polymerizable monomers used in the reaction mixture. The inclusion of constitutional units comprising the residue of an alpha, beta-ethylenically unsaturated carboxylic acids in the dispersant results in a dispersant comprising at least one carboxylic acid group which may assist in providing stability to the dispersion.

The addition polymer may comprise constitutional units comprising the residue of an alkyl esters of (meth)acrylic acid containing from 1 to 3 carbon atoms in the alkyl group. Non-limiting examples of alkyl esters of (meth)acrylic acid containing from 1 to 3 carbon atoms in the alkyl group include methyl (meth)acrylate and ethyl (meth)acrylate. The constitutional units comprising the residue of the alkyl esters of (meth)acrylic acid containing from 1 to 3 carbon atoms in the alkyl group may comprise at least 20% by weight, such as at least 30% by weight, such as at least 40% by weight, such as at least 45% by weight, such as at least 50% by weight, and may be no more than 98% by weight, such as no more than 96% by weight, such as no more than 90% by weight, such as no more than 80% by weight, such as no more than 75% by weight, based on the total weight of the addition polymer. The constitutional units comprising the residue of the alkyl esters of (meth)acrylic acid containing from 1 to 3 carbon atoms in the alkyl group may comprise 20% to 98% by weight, such as 30% to 96% by weight, such as 30% to 90% by weight, 40% to 90% by weight, such as 40% to 80% by weight, such as 45% to 75% by weight, based on the total weight of the addition polymer. The addition polymer may be derived from a reaction mixture comprising the alkyl esters of (meth)acrylic acid containing from 1 to 3 carbon atoms in the alkyl group in an amount of 20% to 98% by weight, such as 30% to 96% by weight, such as 30% to 90% by weight, 40% to 90% by weight, such as 40% to 80% by weight, such as 45% to 75% by weight, based on the total weight of polymerizable monomers used in the reaction mixture.

The addition polymer may comprise constitutional units comprising the residue of an alkyl esters of (meth)acrylic acid containing from 4 to 18 carbon atoms in the alkyl group. Non-limiting examples of alkyl esters of (meth)acrylic acid containing from 4 to 18 carbon atoms in the alkyl group include butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate and dodecyl (meth)acrylate. The constitutional units comprising the residue of the alkyl esters of (meth)acrylic acid containing from 4 to 18 carbon atoms in the alkyl group may comprise at least 2% by weight, such as at least 5% by weight, such as at least 10% by weight, such as at least 15% by weight, such as at least 20% by weight, and may be no more than 70% by weight, such as no more than 60% by weight, such as no more than 50% by weight, such as no more than 40% by weight, such as no more than 35% by weight, based on the total weight of the addition polymer. The constitutional units comprising the residue of the alkyl esters of (meth)acrylic acid containing from 4 to 18 carbon atoms in the alkyl group may comprise 2% to 70% by weight, such as 2% to 60% by weight, such as 5% to 50% by weight, 10% to 40% by weight, such as 15% to 35% by weight, based on the total weight of the addition polymer. The addition polymer may be derived from a reaction mixture comprising the alkyl esters of (meth)acrylic acid containing from 4 to 18 carbon atoms in the alkyl group in an amount of 2% to 70% by weight, such as 2% to 60% by weight, such as 5% to 50% by weight, 10% to 40% by weight, such as 15% to 35% by weight, based on the total weight of polymerizable monomers used in the reaction mixture.

The addition polymer may comprise constitutional units comprising the residue of a hydroxyalkyl ester. Non-limiting examples of hydroxyalkyl esters include hydroxyethyl (meth)acrylate and hydroxypropyl (meth)acrylate. The constitutional units comprising the residue of the hydroxyalkyl ester may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the hydroxyalkyl ester may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the hydroxyalkyl ester in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture. The inclusion of constitutional units comprising the residue of a hydroxyalkyl ester in the dispersant results in a dispersant comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides and blocked polyisocyanates, or with N-alkoxymethyl amide groups or blocked isocyanato groups present in the addition polymer when self-crosslinking monomers that have groups that are reactive with the hydroxyl groups are incorporated into the addition polymer.

The addition polymer may comprise constitutional units comprising the residue of an ethylenically unsaturated monomer comprising a heterocyclic group. Non-limiting examples of ethylenically unsaturated monomers comprising a heterocyclic group include epoxy functional ethylenically unsaturated monomers, such as glycidyl (meth)acrylate, vinyl pyrrolidone and vinyl caprolactam, among others. The constitutional units comprising the residue of the ethylenically unsaturated monomers comprising a heterocyclic group may comprise at least 0.5% by weight, such as at least 1% by weight, such as at least 5% by weight, such as at least 8% by weight, and may be no more than 99% by weight, such as no more than 50% by weight, such as no more than 40% by weight, such as no more than 30% by weight, such as no more than 27% by weight, based on the total weight of the addition polymer. The constitutional units comprising the residue of the ethylenically unsaturated monomers comprising a heterocyclic group may comprise 0.5% to 99% by weight, such as 0.5% to 50% by weight, such as 1% to 40% by weight, such as 5% to 30% by weight, 8% to 27% by weight, based on the total weight of the addition polymer. The addition polymer may be derived from a reaction mixture comprising the ethylenically unsaturated monomers comprising a heterocyclic group in an amount of 0.5% to 50% by weight, such as 1% to 40% by weight, such as 5% to 30% by weight, 8% to 27% by weight, based on the total weight of polymerizable monomers used in the reaction mixture.

As noted above, the addition polymer may comprise constitutional units comprising the residue of a self-crosslinking monomer, and the addition polymer may comprise a self-crosslinking addition polymer. As used herein, the term “self-crosslinking monomer” refers to monomers that incorporate functional groups that may react with other functional groups present on the dispersant to a crosslink between the dispersant or more than one dispersant. Non-limiting examples of self-crosslinking monomers include N-alkoxymethyl (meth)acrylamide monomers such as N-butoxymethyl (meth)acrylamide and N-isopropoxymethyl (meth)acrylamide, as well as self-crosslinking monomers containing blocked isocyanate groups, such as isocyanatoethyl (meth)acrylate in which the isocyanato group is reacted (“blocked”) with a compound that unblocks at curing temperature. Examples of suitable blocking agents include epsilon-caprolactone and methylethyl ketoxime. The constitutional units comprising the residue of the self-crosslinking monomer may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the self-crosslinking monomer may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the self-crosslinking monomer in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The addition polymer may comprise constitutional units comprising the residue of other alpha, beta-ethylenically unsaturated monomers. Non-limiting examples of other alpha, beta-ethylenically unsaturated monomers include vinyl aromatic compounds such as styrene, alpha-methyl styrene, alpha-chlorostyrene and vinyl toluene; organic nitriles such as acrylonitrile and methacrylonitrile; allyl monomers such as allyl chloride and allyl cyanide; monomeric dienes such as 1,3-butadiene and 2-methyl-1,3-butadiene; and acetoacetoxyalkyl (meth)acrylates such as acetoacetoxyethyl methacrylate (AAEM) (which may be self-crosslinking). The constitutional units comprising the residue of the other alpha, beta-ethylenically unsaturated monomers may comprise at least 0.5% by weight, such as at least 1% by weight, such as at least 2% by weight, and may be no more than 30% by weight, such as no more than 20% by weight, such as no more than 10% by weight, such as no more than 5% by weight, based on the total weight of the addition polymer. The constitutional units comprising the residue of the other alpha, beta-ethylenically unsaturated monomers may comprise 0.5% to 30% by weight, such as 1% to 20% by weight, such as 2% to 20% by weight, 2% to 10% by weight, such as 2% to 5% by weight, based on the total weight of the addition polymer. The addition polymer may be derived from a reaction mixture comprising the other alpha, beta-ethylenically unsaturated monomers in an amount of 0.5% to 30% by weight, such as 1% to 20% by weight, such as 2% to 20% by weight, 2% to 10% by weight, such as 2% to 5% by weight, based on the total weight of polymerizable monomers used in the reaction mixture.

The monomers and relative amounts may be selected such that the resulting addition polymer has a Tg of 100° C. or less, typically from −50° C. to +70° C., such as −50° C. to 0° C. A lower Tg that is below 0° C. may be desirable to ensure acceptable battery performance at low temperature.

The addition polymers may be prepared by conventional free radical initiated solution polymerization techniques in which the polymerizable monomers are dissolved in a solvent or a mixture of solvents and polymerized in the presence of a free radical initiator until conversion is complete. The solvent used to produce the addition polymer may comprise any suitable organic solvent or mixture of solvents.

Examples of free radical initiators are those which are soluble in the mixture of monomers such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications.

To prepare the addition polymer, the solvent may be first heated to reflux and the mixture of polymerizable monomers containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

For use in the electrodepositable coating composition of the invention, the dispersants prepared as described above usually have a weight average molecular weight of about 5,000 to 500,000 g/mol, such as 10,000 to 100,000 g/mol, and 25,000 to 50,000 g/mol.

The dispersant may be present in the electrodepositable coating composition in amount of 2% to 35% by weight, such as 5% to 32% by weight, such as 8% to 30% by weight, such as 10% to 30% by weight, such as 15% to 27% by weight, based on the total weight of the binder solids.

The electrodepositable binder may optionally further comprise a non-fluorinated organic film-forming polymer. The non-fluorinated organic film-forming polymer is different than the pH-dependent rheology modifier described herein. The non-fluorinated organic film-forming polymer may comprise polysaccharides, poly(meth)acrylates, polyethylene, polystyrene, polyvinyl alcohol, poly (methyl acrylate), poly (vinyl acetate), polyacrylonitrile, polyimide, polyurethane, polyvinyl butyral, polyvinyl pyrrolidone, styrene butadiene rubber, nitrile rubber, xanthan gum, copolymers thereof, or combinations thereof.

The non-fluorinated organic film-forming polymer may be present, if at all, in an amount of 0% to 90% by weight, such as 10% to 80% by weight, such as 20% to 60% by weight, such as 20% to 50% by weight, such as 25% to 40% by weight, based on the total weight of the binder solids.

The non-fluorinated organic film-forming polymer may be present, if at all, in an amount of at least 0% to 9.9% by weight, such as 0.1% to 5% by weight, such as 0.2% to 2% by weight, such as 0.3% to 0.5% by weight, based on the total solids weight of the electrodepositable coating composition.

The electrodepositable coating composition may also be substantially free, essentially free, or completely free of any or all of the non-fluorinated organic film-forming polymer described herein.

As mentioned above, the electrodepositable binder may optionally further comprise a crosslinking agent. The crosslinking agent should be soluble or dispersible in the aqueous medium and be reactive with active hydrogen groups of the pH-dependent rheology modifier (if the pH-dependent rheology modifier comprises such groups) and/or any other resinous film-forming polymers comprising active hydrogen groups present (if present) in the composition. Non-limiting examples of suitable crosslinking agents include aminoplast resins, blocked polyisocyanates, carbodiimides, and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactam and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Carbodiimide crosslinking agents may be in monomeric or polymeric form, or a mixture thereof. Carbodiimide crosslinking agents refer to compounds having the following structure:

R—N═C═N—R′

wherein R and R′ may each individually comprise an aliphatic, aromatic, alkylaromatic, carboxylic, or heterocyclic group. Examples of commercially available carbodiimide crosslinking agents include, for example, those sold under the trade name CARBODILITE available from Nisshinbo Chemical Inc., such as CARBODILITE V-02-L2, CARBODILITE SV-02, CARBODILITE E-02, CARBODILITE SW-12G, CARBODILITE V-10 and CARBODILITE E-05.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

The crosslinking agent may be present in the electrodepositable coating composition in amounts of 0% to 30% by weight, such as 5% to 20% by weight, such as 5% to 15% by weight, such as 7% to 12% by weight, the % by weight being based on the total weight of the binder solids.

The crosslinking agent may be present in the electrodepositable coating composition in amounts of 0% to 2% by weight, such as 0.1% to 1% by weight, such as 0.2% to 0.8% by weight, such as 0.3% to 0.5% by weight, the % by weight being based on the total solids weight of the electrodepositable coating composition.

Alternatively, the electrodepositable coating composition may be substantially free, essentially free or completely free of crosslinking agent. The electrodepositable coating composition is substantially free or essentially free of crosslinking agent if crosslinking agent is present, if at all, in an amount of less than 3% or less than 1%, respectively, based on the total weight of the binder solids.

The electrodepositable coating composition may optionally further comprise an adhesion promoter. The adhesion promoter may comprise an acid-functional polyolefin or a thermoplastic material.

The acid-functional polyolefin adhesion promoter may comprise an ethylene-(meth)acrylic acid copolymer, such as an ethylene-acrylic acid copolymer or an ethylene-methacrylic acid copolymer. The ethylene-acrylic acid copolymer may comprise constitutional units comprising 10% to 50% by weight acrylic acid, such as 15% to 30% by weight, such as 17% to 25% by weight, such as about 20% by weight, based on the total weight of the ethylene-acrylic acid copolymer, and 50% to 90% by weight ethylene, such as 70% to 85% by weight, such as 75% to 83% by weight, such as about 80% by weight, based on the total weight of the ethylene-acrylic acid copolymer. A commercially available example of such an addition polymer includes PRIMACOR 5980i, available from the Dow Chemical Company.

The adhesion promoter may be present in the electrodepositable coating composition in an amount of 1% to 60% by weight, such as 10% to 40% by weight, such as 25% to 35% by weight, based on the total weight of the binder solids (including the adhesion promoter).

Alternatively, the electrodepositable coating composition may be substantially free, essentially free or completely free of adhesion promoter. The electrodepositable coating composition is substantially free or essentially free of adhesion promoter if adhesion promoter is present, if at all, in an amount of less than 1% or less than 0.1%, respectively, based on the total weight of the binder solids.

The electrodepositable coating composition may optionally comprise a catalyst to catalyze the reaction between the curing agent and the active hydrogen-containing resin(s). Suitable catalysts include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate). The catalyst may also comprise an organic compound such as a guanidine. For example, the guanidine may comprise a cyclic guanidine as described in U.S. Pat. No. 7,842,762 at col. 1, line 53 to col. 4, line 18 and col. 16, line 62 to col. 19, line 8, the cited portions of which being incorporated herein by reference. Alternatively, the composition may comprise metal-free catalysts based on imidazoles as described in publication WO2019066029A1. If present, the catalyst may be present in an amount of 0.01% to 5% by weight, such as 0.1% to 2% by weight, based on the total weight of the binder solids.

Alternatively, the electrodepositable coating composition may be substantially free, essentially free, or completely free of catalyst. The electrodepositable coating composition is substantially free or essentially free of catalyst if catalyst is present, if at all, in an amount of less than 0.01% or less than 0.001%, respectively, based on the total weight of the binder solids.

As used herein, the term “binder solids” may be used synonymously with “resin solids” and includes any film-forming polymer, such as those described above, and, if present, the curing agent. For example, the binder solids of the electrodepositable binder include, if present, the pH-dependent rheology modifier, the fluoropolymer, the dispersant, the adhesion promoter, the non-fluorinated organic film-forming polymer, and the separately added crosslinking agent, as described above. The binder solids do not include the electrochemically active material and electrically conductive agent, if present. As used herein, the term “binder dispersion” refers to a dispersion of the binder solids in the aqueous medium.

The electrodepositable binder may comprise, consist essentially of, or consist of the an ionic, film-forming resin in an amount of 10% to 100% by weight, such as 50% to 95% by weight, such as 70% to 93% by weight, such as 87% to 92% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may comprise, consist essentially of, or consist of the pH-dependent rheology modifier in an amount of 10% to 100% by weight, such as 50% to 95% by weight, such as 70% to 93% by weight, such as 87% to 92% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may comprise, consist essentially of, or consist of the pH-dependent rheology modifier in an amount of 10% to 100% by weight, such as 50% to 95% by weight, such as 70% to 93% by weight, such as 87% to 92% by weight; the fluoropolymer in an amount of 15% to 99% by weight, such as 30% to 96% by weight, such as 40% to 95% by weight, such as 50% to 90% by weight, such as 70% to 90% by weight, such as 80% to 90% by weight, such as 50% to 80% by weight, such as 50% to 70% by weight, such as 50% to 60% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may comprise, consist essentially of, or consist of the pH-dependent rheology modifier in an amount of 10% to 100% by weight, such as 50% to 95% by weight, such as 70% to 93% by weight, such as 87% to 92% by weight; the fluoropolymer in an amount of 15% to 99% by weight, such as 30% to 96% by weight, such as 40% to 95% by weight, such as 50% to 90% by weight, such as 70% to 90% by weight, such as 80% to 90% by weight, such as 50% to 80% by weight, such as 50% to 70% by weight, such as 50% to 60% by weight; the dispersant in an amount of 2% to 35% by weight, such as 5% to 32% by weight, such as 8% to 30% by weight, such as 15% to 27% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may comprise, consist essentially of, or consist of the pH-dependent rheology modifier in an amount of 10% to 100% by weight, such as 50% to 95% by weight, such as 70% to 93% by weight, such as 87% to 92% by weight; the fluoropolymer in an amount of 15% to 99% by weight, such as 30% to 96% by weight, such as 40% to 95% by weight, such as 50% to 90% by weight, such as 70% to 90% by weight, such as 80% to 90% by weight, such as 50% to 80% by weight, such as 50% to 70% by weight, such as 50% to 60% by weight; the dispersant in an amount of 2% to 35% by weight, such as 5% to 32% by weight, such as 8% to 30% by weight, such as 15% to 27% by weight; the adhesion promoter in an amount of 1% to 60% by weight, such as 10% to 40% by weight, such as 25% to 35% by weight; the non-fluorinated organic film-forming polymer, if present, in an amount of 0% to 90% by weight, such as 20% to 60% by weight, such as 25% to 40% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may comprise, consist essentially of, or consist of the pH-dependent rheology modifier in an amount of 10% to 100% by weight, such as 50% to 95% by weight, such as 70% to 93% by weight, such as 87% to 92% by weight; the adhesion promoter, if present, in an amount of 1% to 60% by weight, such as 10% to 40% by weight, such as 25% to 35% by weight; the non-fluorinated organic film-forming polymer, if present, in an amount of 0% to 90% by weight, such as 20% to 60% by weight, such as 25% to 40% by weight; and the crosslinking agent, if present, in amounts of 0 to 30% by weight, such as 5% to 15% by weight, such as 7% to 13% by weight, the % by weight being based on the total weight of the binder solids.

The electrodepositable binder may be present in the electrodepositable coating composition in amounts of 0.1% to 20% by weight, such as 0.2% to 10% by weight, such as 0.3% to 8% percent by weight, such as 0.5% to 5% by weight, such as 1% to 5% by weight, such as 1% to 3% by weight, such as 1.5% to 2.5% by weight, such as 1% to 2% by weight, based on the total solids weight of the electrodepositable coating composition.

The electrodepositable coating composition of the present invention may optionally further comprise an electrically conductive agent when the electrochemically active material comprises a material for use as an active material for a positive electrode. Non-limiting examples of electrically conductive agents include carbonaceous materials such as, activated carbon, carbon black such as acetylene black and furnace black, graphite, graphene, carbon nanotubes, carbon fibers, fullerene, and combinations thereof. It should be noted graphite may be used as both an electrochemically active material for negative electrodes as well as an electrically conductive agent, but an electrically conductive material is typically omitted when graphite is used as the electrochemically active material.

In addition to the material described above, the electrically conductive agent may comprise an active carbon having a high-surface area, such as, for example, a BET surface area of greater than 100 m²/g. As used herein, the term “BET surface area” refers to a specific surface area determined by nitrogen adsorption according to the ASTM D 3663-78 standard based on the Brunauer-Emmett-Teller method described in the periodical “The Journal of the American Chemical Society”, 60, 309 (1938). In some examples, the conductive carbon can have a BET surface area of 100 m²/g to 1,000 m²/g, such as 150 m²/g to 600 m²/g, such as 100 m²/g to 400 m²/g, such as 200 m²/g to 400 m²/g. In some examples, the conductive carbon can have a BET surface area of about 200 m²/g. A suitable conductive carbon material is LITX 200 commercially available from Cabot Corporation.

The electrically conductive agent may optionally comprise a protective coating comprising the same coating materials as discussed above with respect to the electrochemically active material comprising a protective coating.

The electrically conductive agent may be present in the electrodepositable coating composition in amounts of 0.5% to 20% by weight, such as 0.5% to 5% by weight, such as 0.5% to 3% by weight, such as 0.5% to 2% by weight, such as 0.5% to 1% by weight, such as 1% to 20% by weight, such as 2% to 10% by weight, such as 2.5% to 7% by weight, such as 3% to 5% by weight, based on the total solids weight of the electrodepositable coating composition.

Alternatively, the electrodepositable coating composition may be substantially free, essentially free, or free of an electrically conductive agent. As used herein, an electrodepositable coating composition free of the electrically conductive agent is in reference to the electrically conductive agent being used in combination with one of the electrochemically active materials used above. An electrodepositable coating composition is substantially free or essentially free of electrically conductive agent if it is present, if at all, in an amount of less than 0.1% by weight or 0.01% by weight, respectively, based on the total solids weight of the electrodepositable coating composition.

According to the present invention, the electrodepositable coating composition further comprises an aqueous medium comprising water. As used herein, the term “aqueous medium” refers to a liquid medium comprising more than 50% by weight water, based on the total weight of the aqueous medium. Such aqueous mediums may comprise less than 50% by weight organic solvent, or less than 40% by weight organic solvent, or less than 30% by weight organic solvent, or less than 20% by weight organic solvent, or less than 10% by weight organic solvent, or less than 5% by weight organic solvent, or less than 1% by weight organic solvent, less than 0.8% by weight organic solvent, or less than 0.1% by weight organic solvent, based on the total weight of the aqueous medium. Water may comprise 50.1% to 100% by weight, such as 70% to 100% by weight, such as 80% to 100% by weight, such as 85% to 100% by weight, such as 90% to 100% by weight, such as 95% to 100% by weight, such as 99% to 100% by weight, such as 99.9% to 100% by weight, based on the total weight of the aqueous medium. The aqueous medium may further comprise one or more organic solvent(s). Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. The electrodepositable coating composition may be provided in the form of a dispersion, such as an aqueous dispersion.

Water may be present in the aqueous medium such that the total amount of water present in the electrodepositable coating composition in an amount of 40% to 99% by weight, such as 45% to 99% by weight, such as 50% to 99% by weight, such as 60% to 99% by weight, such as 65% to 99% by weight, such as 70% to 99% by weight, such as 75% to 99% by weight, such as 80% to 99% by weight, such as 85% to 99% by weight, such as 90% to 99% by weight, such as 40% to 90% by weight, such as 45% to 85% by weight, such as 50% to 80% by weight, such as 60% to 75% by weight, based on the total weight of the electrodepositable coating composition.

The total solids content of the electrodepositable coating composition may be at least 0.1% by weight, such as at least 1% by weight, such as at least 3% by weight, such as at least 5% by weight, such as at least 7% by weight, such as at least 10% by weight, such as at least at least 20% by weight, such as at least 30% by weight, such as at least 40% by weight, based on the total weight of the electrodepositable coating composition. The total solids content may be no more than 60% by weight, such as no more than 50% by weight, such as no more than 40% by weight, such as no more than 30% by weight, such as no more than 25% by weight, such as no more than 20% by weight, such as no more than 15% by weight, such as no more than 12% by weight, such as no more than 10% by weight, such as no more than 7% by weight, such as no more than 5% by weight, based on the total weight of the electrodepositable coating composition. The total solids content of the electrodepositable coating composition may be 0.1% to 60% by weight, such as 0.1% to 50% by weight, such as 0.1% to 40% by weight, such as 0.1% to 30% by weight, such as 0.1% to 25% by weight, such as 0.1% to 20% by weight, such as 0.1% to 15% by weight, such as 0.1% to 12% by weight, such as 0.1% to 10% by weight, such as 0.1% to 7% by weight, such as 0.1% to 5% by weight, such as 0.1% to 1% by weight, such as 1% to 60% by weight, such as 1% to 50% by weight, such as 1% to 40% by weight, such as 1% to 30% by weight, such as 1% to 25% by weight, such as 1% to 20% by weight, such as 1% to 15% by weight, such as 1% to 12% by weight, such as 1% to 10% by weight, such as 1% to 7% by weight, such as 1% to 5% by weight based on the total weight of the electrodepositable coating composition.

The electrodepositable coating composition may comprise, consist essentially of, or consist of the electrochemically active material in an amount of 45% to 99% by weight, such as 70% to 99% by weight, such as 80% to 99% by weight, such as 90% to 99% by weight, such as 91% to 99% by weight, such as 91% to 99% by weight, such as 94% to 99% by weight, such as 95% to 99% by weight, such as 96% to 99% by weight, such as 97% to 99% by weight; the electrodepositable binder in an amount of 0.1% to 20% by weight, such as 0.2% to 10% by weight, such as 0.3% to 8% percent by weight, such as 0.5% to 5% by weight, such as 1% to 3% by weight, such as 1.5% to 2.5% by weight, such as 1% to 2% by weight, based on the total solids weight of the electrodepositable coating composition; and optionally the electrically conductive agent in an amount of 0.5% to 20% by weight, such as 1% to 20% by weight, such as 2% to 10% by weight, such as 2.5% to 7% by weight, such as 3% to 5% by weight, based on the total solids weight of the electrodepositable coating composition.

The pH of the electrodepositable coating composition will depend upon the type of electrodeposition in which the composition is to be used, as well as additives, such as pigments, fillers, and the like, included in the electrodepositable coating composition. The selection of electrochemically active material in particular can significantly impact the pH of the electrodepositable coating composition. For example, an anionic electrodepositable coating composition may have a pH from about 6 to about 12, such as about 6.5 to about 11, such as about 7 to about 10.5. In contrast, a cationic electrodepositable coating composition may have a pH from about 4.5 to about 10, such as about 4.5 to about 5.5, such as about 8 to about 9.5.

The electrodepositable coating composition may optionally further comprise a pH adjustment agent. The pH adjustment agent may comprise an acid or base. The acid may comprise, for example, phosphoric acid or carbonic acid. The base may comprise, for example, lithium hydroxide, lithium carbonate, or dimethylethanolamine (DMEA). Any suitable amount of pH adjustment agent needed to adjust the pH of the electrodepositable coating composition to the desired pH range may be used.

The electrodepositable coating composition may be substantially free, essentially free, or completely free of N-methyl-2-pyrrolidone (NMP). The electrodepositable coating composition may also be substantially free, essentially free, or completely free of further fugitive adhesion promoter. As used herein, the term “fugitive adhesion promoter” refers to N-methyl-2-pyrrolidone (NMP), dimethylformamide, N,N-dimethylacetamide, dimethylsulfoxide (DMSO), hexamethylphosphamide, dioxane, tetrahydrofuran, tetramethylurea, triethyl phosphate, trimethyl phosphate, dimethyl succinate, diethyl succinate and tetraethyl urea. As used herein, an electrodepositable coating composition substantially free of fugitive adhesion promoter if it includes less than 1% by weight fugitive adhesion promoter, if any at all, based on the total weight of the electrodepositable coating composition. As used herein, an electrodepositable coating composition essentially free of fugitive adhesion promoter if it includes less than 0.1% by weight fugitive adhesion promoter, if any at all, based on the total weight of the electrodepositable coating composition. When present, the fugitive adhesion promoter may be present in an amount of less than 2% by weight, such as less 1% by weight, such as less than 0.9% by weight, such as less than 0.1% by weight, such as less than 0.01% by weight, such as less than 0.001% by weight, based on the total weight of the electrodepositable coating composition.

According to the present invention, the electrodepositable coating composition may be substantially free, essentially free or completely free of fluoropolymer.

The electrodepositable coating composition may be substantially free, essentially free, or completely free of organic carbonate. As used herein, an electrodepositable composition is substantially free or essentially free of organic carbonate when organic carbonate is present, if at all, in an amount less than 1% by weight or less than 0.1% by weight, respectively, based on the total weight of the electrodepositable coating composition.

The electrodepositable coating composition may be substantially free, essentially free, or completely free of acrylic-modified fluoropolymer. As used herein, an electrodepositable composition is substantially free or essentially free of acrylic-modified fluoropolymer when acrylic-modified fluoropolymer is present, if at all, in an amount less than 1% by weight or less than 0.1% by weight, respectively, based on the total binder solids weight of the electrodepositable coating composition.

According to the present invention, the electrodepositable coating composition may be substantially free, essentially free or completely free of polyethylene, polytetrafluoroethylene, tetrafluoroethylene-hexafluoropropylene copolymer, and/or polyacrylonitrile derivatives.

The electrodepositable coating may be substantially free, essentially free, or completely free of isophorone.

The electrodepositable coating composition may be substantially free, essentially free, or completely free of organic carbonate. As used herein, an electrodepositable composition is substantially free or essentially free of organic carbonate when organic carbonate is present, if at all, in an amount less than 1% by weight or less than 0.1% by weight, respectively, based on the total weight of the electrodepositable coating composition.

The electrodepositable coating composition may be substantially free of acrylonitrile. As used herein, an electrodepositable composition is substantially free or essentially free of acrylonitrile when acrylonitrile is present, if at all, in an amount less than 1% by weight or less than 0.1% by weight, respectively, based on the total weight of the electrodepositable coating composition.

The electrodepositable coating composition may be substantially free of graphene oxide. As used herein, an electrodepositable composition is substantially free or essentially free of graphene oxide when graphene oxide is present, if at all, in an amount less than 5% by weight or less than 1% by weight, respectively, based on the total weight of the electrodepositable coating composition.

The pH-dependent rheology modifier may be substantially free, essentially free, or completely free of the residue of a carboxylic acid amide monomer unit. As used herein, a pH-dependent rheology modifier is substantially free or essentially free of carboxylic acid amide monomer units when carboxylic acid amide monomer units are present, if at all, in an amount less than 0.1% by weight or less than 0.01% by weight, respectively, based on the total weight of the pH-dependent rheology modifier.

The electrodepositable coating may be substantially free of isophorone. As used herein, an electrodepositable composition is substantially free or essentially free of isophorone when isophorone is present, if at all, in an amount less than 5% by weight or less than 1% by weight, respectively, based on the total weight of the electrodepositable coating composition.

The electrodepositable coating may be substantially free, essentially free, or completely free of isophorone.

The electrodepositable coating may be substantially free, essentially free, or completely free of a cellulose derivative. Non-limiting examples of cellulose derivatives includes carboxymethylcellulose and salts thereof (CMC). CMC is a cellulosic ether in which a portion of the hydroxyl groups on the anhydroglucose rings are substituted with carboxymethyl groups.

The electrodepositable coating may be substantially free, essentially free, or completely free of multi-functional hydrazide compounds. As used herein, an electrodepositable composition is substantially free or essentially free of multi-functional hydrazide compounds when multi-functional hydrazide compounds are present, if at all, in an amount less than 0.1% by weight or less than 0.01% by weight, respectively, based on the total binder solids weight of the electrodepositable coating composition.

The electrodepositable coating may be substantially free, essentially free, or completely free of styrene-butadiene rubber (SBR), acrylonitrile butadiene rubber or acrylic rubber. As used herein, an electrodepositable composition is substantially free or essentially free of styrene-butadiene rubber (SBR), acrylonitrile butadiene rubber or acrylic rubber when styrene-butadiene rubber (SBR), acrylonitrile butadiene rubber or acrylic rubber is present, if at all, in an amount less than 5% by weight or less than 1% by weight, respectively, based on the total binder solids weight of the electrodepositable coating composition.

The electrodepositable coating may be substantially free, essentially free, or completely free of poly(meth)acrylic acid having more than 70% by weight (meth)acrylic acid functional monomers, based on the total weight of the poly(meth)acrylic acid. As used herein, an electrodepositable composition is substantially free or essentially free of the poly(meth)acrylic acid when the poly(meth)acrylic acid is present, if at all, in an amount less than 5% by weight or less than 1% by weight, respectively, based on the total binder solids weight of the electrodepositable coating composition.

The electrodepositable coating composition may be substantially free, essentially free, or completely free of particulate polymers containing the residue of an aliphatic conjugated diene monomer unit and an aromatic vinyl monomer unit. As used herein, an electrodepositable composition is substantially free or essentially free of such particulate polymers when the particulate polymer is present, if at all, in an amount less than 5% by weight or less than 1% by weight, respectively, based on the total weight of the binder solids.

The present invention is also directed to methods for preparing the electrode of the present invention. The method for preparing the electrode of the present invention comprises at least partially immersing a porous electrical current collector comprising a surface comprising a plurality of apertures into a bath comprising an electrodepositable coating composition comprising an electrochemically active material and an electrodepositable binder (such as those described above), and electrodepositing a conformal coating deposited from the electrodepositable coating composition onto a portion of the porous electrical current collector immersed in the bath, wherein the conformal coating comprises the electrochemically active material and the electrodepositable binder.

In the electrodeposition process of the method of the invention, the porous electrical current collector serves as an electrode in electrical communication with a counter-electrode which are both immersed (at least partially) in a bath comprising an electrodepositable coating composition. The porous electrical current collector may serve as an anode in anionic electrodeposition or a cathode in cathodic electrodeposition. An electric current is passed between the electrodes to cause the solid components of the electrodepositable coating composition to migrate towards the porous electrical current collector and deposit as a continuous film on the surface and within the apertures thereof. The applied voltage may be varied and can be, for example, as low as one volt to as high as several thousand volts but is often between 50 and 500 volts. The current density is often between 0.5 ampere and 15 amperes per square foot. The residence time of the applied electrical potential to the substrate in the composition may be from 10 to 180 seconds.

The method may optionally further comprise drying and/or curing the deposited conformal coating of the electrode after it is removed from the bath. For example, after electrocoating the porous electrical current collector having the conformal coating may be removed from the bath and baked in an oven to dry and/or crosslink the electrodeposited coating film. For example, the coated substrate may be baked at temperatures of 400° C. or lower, such as 300° C. or lower, such as 275° C. or lower, such as 255° C. or lower, such as 225° C. or lower, such as 200° C. or lower, such as at least 50° C., such as at least 60° C., such as 50-400° C., such as 100-300° C., such as 150-280° C., such as 200-275° C., such as 225-270° C., such as 235-265° C., such as 240-260° C. The time of heating will depend somewhat on the temperature. Generally, higher temperatures require less time for curing. Typically, curing times are for at least 5 minutes, such as 5 to 60 minutes. The temperature and time should be sufficient such that the electrodepositable binder in the cured film is crosslinked (if applicable), that is, covalent bonds are formed between co-reactive groups on the film-forming polymer and the crosslinking agent. In other cases, after electrocoating and removal of the porous electrical current collector having the conformal coating from the bath the porous electrical current collector having the conformal coating may simply be allowed to dry under ambient conditions. As used herein, “ambient conditions” refers to atmospheric air having a relative humidity of 10 to 100 percent and a temperature in the range of −10 to 120° C., such as 5 to 80° C., such as 10 to 60° C. and, such as 15 to 40° C. Other methods of drying the coating film include microwave drying and infrared drying, and other methods of curing the coating film include e-beam curing and UV curing.

The present invention is also directed to an electrical storage device. An electrical storage device according to the present invention may be manufactured by using one or more of the above electrodes of the present invention. The electrical storage device comprises an electrode of the present invention, a counter electrode and an electrolyte. The electrode, counter-electrode or both may comprise the electrode of the present invention, as long as one electrode is a positive electrode and one electrode is a negative electrode. Electrical storage devices according to the present invention include a cell, a battery, a battery pack, a secondary battery, a capacitor, a pseudocapacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis.

The term “glass transition temperature” is a theoretical value being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the electrodepositable coating composition.

As used herein, unless otherwise defined, the term essentially free means that the component is present, if at all, in an amount of less than 1% by weight, based on the total weight of the electrodepositable coating composition.

As used herein, unless otherwise defined, the term completely free means that the component is not present in the electrodepositable coating composition, i.e., 0.00% by weight, based on the total weight of the electrodepositable coating composition.

As used herein, the term “total solids” refers to the non-volatile components of the electrodepositable coating composition of the present invention and specifically excludes the aqueous medium. The total solids explicitly include at least the binder solids, electrochemically active material, and, if present, the electrically conductive agent.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” fluoropolymer, “an” electrochemically active material, and “a” modifier with pH-dependent rheology, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, an electrodepositable coating composition “deposited onto” a substrate does not preclude the presence of one or more other intervening coating layers of the same or different composition located between the electrodepositable coating composition and the substrate.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

In view of the foregoing, the present invention thus relates, without being limited thereto, to the following aspects:

Aspect 1. An electrode comprising: a porous electrical current collector comprising a surface comprising a plurality of apertures; a conformal coating present on at least a portion of the surface of the porous electrical current collector, the conformal coating comprising an electrochemically active material and an electrodepositable binder.

Aspect 2. The electrode of Aspect 1, wherein the conformal coating is present as a film over the surface of the porous electrical current collector and within the apertures.

Aspect 3. The electrode of Aspects 1 or 2, wherein the film present within the apertures comprises a continuous film that spans the apertures.

Aspect 4. The electrode of Aspect 1, wherein the conformal coating is present as a film over the surface of the porous electrical current collector and does not fill the apertures.

Aspect 5. The electrode of any of Aspects 1-3, wherein the thickness of the conformal coating film within the apertures is within 50% of the thickness of the conformal coating film on the surface of the porous electrical current collector.

Aspect 6. The electrode of any of the preceding Aspects, wherein the thickness of the conformal coating on the conductive material and within the apertures is from 0.5 microns to 1,000 microns.

Aspect 7. The electrode of any of the preceding Aspects, wherein the apertures are uniformly distributed over the surface of the porous electrical current collector.

Aspect 8. The electrode of any of the preceding Aspects, wherein the apertures have a diameter of 500 microns or less.

Aspect 9. The electrode of any of the preceding Aspects, wherein the diameter of the apertures is no more than 10 times the thickness of the porous electrical current collector.

Aspect 10. The electrode of any of the preceding Aspects, wherein the apertures have an average longest dimension of 1,000 microns or less.

Aspect 11. The electrode of any of the preceding Aspects, wherein the porous electrical current collector comprises aluminum, copper, steel, stainless steel, nickel, conductive carbon, a porous substrate with a conductive coating, or a conductive polymer.

Aspect 12. The electrode of any of the preceding Aspects, wherein the electrodepositable binder comprises a pH-dependent rheology modifier.

Aspect 13. The electrode of any of the preceding Aspects, wherein the electrodepositable binder comprises a fluoropolymer.

Aspect 14. The electrode of any of the preceding Aspects, wherein the electrodepositable binder comprises a non-fluorinated organic film-forming polymer.

Aspect 15. The electrode of any of the preceding Aspects, wherein the electrochemically active material comprises LiCoO₂, LiNiO₂, LiFePO₄, LiFeCoPO₄, LiCoPO₄, LiMnO₂, LiMn₂O₄, Li(NiMnCo)O₂, Li(NiCoAl)O₂, carbon-coated LiFePO₄, sulfur, LiO₂, FeF₂ and FeF₃, aluminum, SnCo, Fe₃O₄, or combinations thereof.

Aspect 16. The electrode of any of Aspects 1-14, wherein the electrochemically active material comprises graphite, lithium titanate, lithium vanadium phosphate, silicon, silicon compounds, tin, tin compounds, sulfur, sulfur compounds, lithium metal, graphene, or a combination thereof.

Aspect 17. The electrode of any of Aspects 1-15, wherein the conformal coating further comprises an electrically conductive agent.

Aspect 18. The electrode of any of the preceding Aspects, wherein the conformal coating further comprises a crosslinking agent.

Aspect 19. The electrode of any of Aspects 1-15 or 17-18, wherein the electrode comprises a positive electrode.

Aspect 20. The electrode of any of Aspects 1-14 or 18, wherein the electrode comprises a negative electrode.

Aspect 21. An electrical storage device comprising: (a) the electrode of any of the preceding Aspects; (b) a counter-electrode; and (c) an electrolyte.

Aspect 22. The electrical storage device of Aspect 21, wherein the electrical storage device comprises a cell.

Aspect 23. The electrical storage device of Aspect 21, wherein the electrical storage device comprises a battery pack.

Aspect 24. The electrical storage device of Aspect 21, wherein the electrical storage device comprises a secondary battery.

Aspect 25. The electrical storage device of Aspect 21, wherein the electrical storage device comprises a capacitor.

Aspect 26. The electrical storage device of Aspect 21, wherein the electrical storage device comprises a supercapacitor.

Aspect 27. A method of preparing an electrode, the method comprising: at least partially immersing a porous electrical current collector comprising a surface comprising a plurality of apertures into a bath comprising an electrodepositable coating composition comprising an electrochemically active material and an electrodepositable binder; electrodepositing a conformal coating deposited from the electrodepositable coating onto a portion of the porous electrical current collector immersed in the bath, wherein the conformal coating comprises the electrochemically active material and the electrodepositable binder.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1

Preparation of a dispersant: The dispersant was prepared using a two-step process. In a first step, 493.2 grams of diacetone alcohol was added to a four-neck round bottom flask equipped with a mechanical stir blade, thermocouple, and reflux condenser. The diacetone alcohol was heated to a set point of 122° C. under a nitrogen atmosphere. A monomer solution containing 290.4 grams of methyl methacrylate, 295 grams of ethylhexyl acrylate, 51.5 grams of butyl acrylate, 187.3 grams of N-vinyl pyrrolidone, and 112.4 grams of methacrylic acid was thoroughly mixed in a separate container. An initiator solution of 9.1 grams of tert-amyl peroctoate and 163.8 grams of diacetone alcohol was also prepared in a separate container. The initiator and monomer solutions were co-fed into the flask at the same time using addition funnels over 210 and 180 minutes, respectively. After the initiator and monomer feeds were complete, the monomer addition funnel was rinsed with 46.8 grams of diacetone alcohol and the initiator addition funnel was rinsed with 23 grams of diacetone alcohol. The resulting solution was held at 122° C. for 1 hour. Next, 200 grams of diacetone alcohol was added to the reactor followed by a second initiator solution of 2.8 grams of tert-amyl peroctoate and 24.5 grams of diacetone alcohol which was added over 30 minutes. The solution was held at 122° C. for 60 minutes. Then a third initiator solution of 2.8 grams of tert-amyl peroctoate and 24.5 grams of diacetone alcohol was added over 30 minutes. The solution was then held at 122° C. for 60 minutes. After the 60-minute hold, the solution was cooled to less than 100° C. and poured into a suitable container. The total solids content of the composition was measured to be 52.74% solids.

In a second step, 462 grams of above composition from step 1 was added to a four-neck round bottom flask equipped with a mechanical stir blade, thermocouple, and reflux condenser. The solution was heated to a set point of 100° C. under a nitrogen atmosphere. Next, 32.8 grams of dimethyl ethanolamine was added over 10 min. After the addition, the solution was held at 100° C. for 15 min and then cooled to 70° C. Once the solution reached 70° C., 541.5 grams of warm (70° C.) deionized water was added over 60 minutes and was mixed for 15 minutes. After mixing, the dispersant was poured into a suitable container. The total solids content of the dispersant composition was measured to be 22.9% solids.

Solids contents of the compositions were determined by the following procedure: An aluminum weighing dish from Fisher Scientific, was weighed using an analytical balance. The weight of the empty dish was recorded to four decimal places. Approximately 0.5 g of the composition and 3.5 g of acetone was added to the pre-weighed dish. The weight of the dish and the dispersant solution was recorded to four decimal places. The dish containing the dispersant solution was placed into a laboratory oven, with the oven temperature set to 110° C. and dried for 1 hour. The pre-weighed dish with remaining solid material was weighed using an analytical balance. The weight of the dish with remaining solid material was recorded to four decimal places. The solids content was determined using the following equation: % solids=100×[(weight of the dish with remaining solids)−(weight of the empty dish)]/[(weight of the dish composition prior to heating)−(weight of the empty dish)].

Preparation of a PVDF dispersion: 96.27 grams of deionized water, 121.85 grams (27.79 grams of solid material) of the dispersant composition prepared above, and 0.16 grams of a de-foaming agent (Drewplus™) were combined in a plastic cup. The resultant mixture was stirred vigorously using a Cowles blade while maintaining a modest vortex at 1200 RPMs. The mixing was continued while 64.8 grams of polyvinylidene difluoride powder (RZ-49 available from Asambly Chemical) was added in small portions of about 0.5 grams over 5 minutes. Mixing was continued for an additional 45 minutes after all the polyvinylidene difluoride powder was added.

Preparation and electrodeposition of electrodepositable coating composition: To plastic cup was added 2.232 g of a pH-dependent rheology modifier (0.62 g of solid material, ACRYSOL HASE TT-615, available from Dow Chemical Co.), 1.91 g of the waterborne PVDF dispersion described above (0.62 g of solid material), 23 g of water, and 0.347 g of a carbodiimide crosslinking agent (0.149 g of solid material, CARBODILITE V-02-L2, available from Nisshinbo Chemical Inc.). This mixture was mixed in a centrifugal mixer at 2000 RPMS for 5 minutes. Next, 25 g (90 wt. %) of an electrochemically active material for a positive electrode (nickel manganese cobalt) was added to the mixture and mixed in a centrifugal mixture at 2000 RPMS for 5 minutes. Next, 1.389 g (5 wt. %) of an electrically conductive agent (“Super P” carbon black commercially available from Imerys) was added to the mixture and mixed in a centrifugal mixer at 2000 RPMs for 5 minutes. Finally, 1.0 g of Hexyl CELLOSOLVE from DOW Chemical Co. was added to the composition and mixed in a centrifugal mixer at 2000 RPMs for 5 minutes. The composition was diluted to 10% total solids by the addition of 170 g of water under constant stirring. After 30 minutes of stirring, electrocoat was performed. A 5 cm×8 cm piece of aluminum mesh having a 200×200 mesh size and 0.0029″ opening size (“Al Mesh Wire Cloth” from McMaster-Carr) was immersed 3 cm into the electrodepositable coating composition. A 4 cm×6 cm Aluminum counter electrode immersed 3 cm in the electrodepositable coating composition was used as the counter-electrode. The electrodepositable coating composition was stirred using a magnetic stirrer throughout the duration of the electrodeposition, and a 100V electrical potential was applied across the electrodes using a direct current rectifier for four different time durations. After electrodeposition, the coated mesh was rinsed with 1 cup of deionized water, left to dry overnight and then weighed to determine the amount of material that was deposited during electrodeposition. Depositions after 5 s, 10 s, 20 s and 30 s yielded masses of 8.07 mg/cm², 23.53 mg/cm², 38.47 mg/cm² and 36.33 mg/cm², respectively.

The coatings for each deposition time formed uniform coatings that were conformal and mapped the mesh geography of the aluminum mesh substrate. The 10 second film had the best appearance and uniformity with a total thickness (including the conformal coating layer and substrate) of 200 microns. The conforming coating film formed a continuous film that spanned all of the apertures in the coated region, and the conformal coating film mapped the underlying mesh substrate geometry.

FIGS. 5A and 5B are optical images at 20-micron scale of the mesh substrate coated for a 10 second deposition rate. These images show the surface profile of the conformal coating of the electrode.

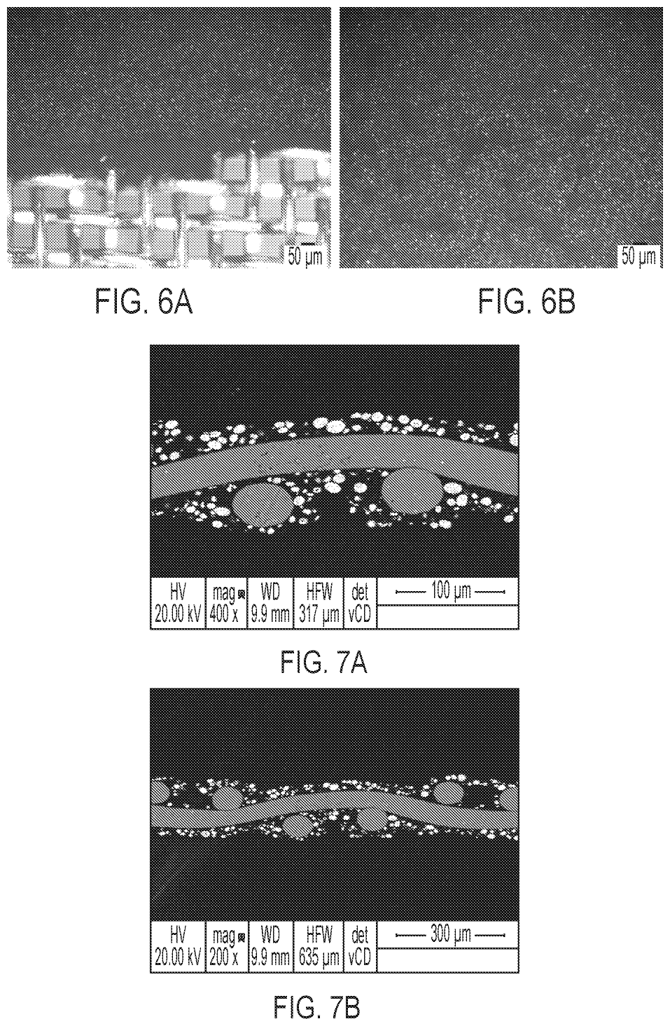

FIGS. 6A and 6B are optical images at 50-micron scale of the mesh substrate coated for a 10 second deposition rate. FIG. 6A shows an un-coated portion and edge profile while FIG. 6B shows an entirely coated portion. These images show the surface profile of the conformal coating of the electrode.

FIGS. 7A and 7B are cross-section field emission scanning electron microscopy (FE-SEM) analysis of the mesh substrate coated for a 5 second deposition rate. FIG. 7A is a high magnification (100-micron scale) and FIG. 7B is a low magnification (300-micron scale). These images show the coating conforming to the wires and surface profile of the mesh.

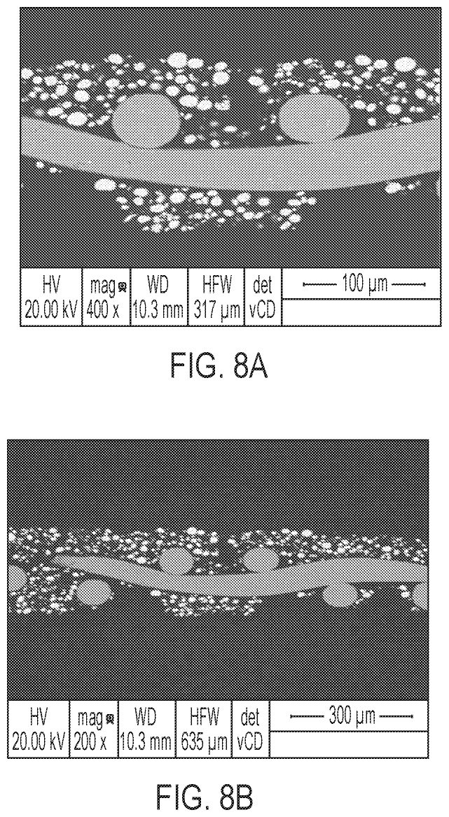

FIGS. 8A and 8B are cross-section field emission scanning electron microscopy (FE-SEM) analysis of the mesh substrate coated for a 10 second deposition rate. FIG. 8A is a high magnification (100 um scale) and FIG. 8B is a low magnification (300 um scale). These images show the coating conforming to the wires and surface profile of the mesh.

### Comparative Example 2

Preparation of a waterborne slurry: A waterborne slurry composition was prepared as follows: To plastic cup was added 2.232 g of a pH-dependent rheology modifier (0.62 g of solid material, ACRYSOL HASE TT-615, available from Dow Chemical Co.), 1.91 g of the waterborne PVDF dispersion described above in Example 1 (0.62 g of solid material), 23 g of water, and 0.347 g of a carbodiimide crosslinking agent (0.149 g of solid material, CARBODILITE V-02-L2, available from Nisshinbo Chemical Inc.). This mixture was mixed in a centrifugal mixer at 2000 RPMS for 5 minutes. Next, 25 g (90 wt. %) of an electrochemically active material for a positive electrode (nickel manganese cobalt) was added to the mixture and mixed in a centrifugal mixture at 2000 RPMS for 5 minutes. Next, 1.389 g (5 wt. %) of an electrically conductive agent (“Super P” carbon black commercially available from Imerys) was added to the mixture and mixed in a centrifugal mixer at 2000 RPMs for 5 minutes. Finally, 1.0 g of Hexyl CELLOSOLVE from DOW Chemical Co. was added to the composition and mixed in a centrifugal mixer at 2000 RPMs for 5 minutes. The slurry was cast onto a 5 cm×8 cm piece of aluminum mesh having a 200×200 mesh size and 0.0029″ opening size (“Al Mesh Wire Cloth” from McMaster-Carr) using an automatic drawdown table with a variable gap heights of 15 mils (resulting in a total thickness including the coating film and substrate of 180 microns) and 20 mils (resulting in a total thickness including the coating film and substrate of 220 microns). In contrast to the mesh substrates coated by electrodeposition above, the mesh substrates coated by the drawdown method did not form uniform, conformal coatings on the mesh substrate. The resulting coating films were not uniform. In addition, the coating film did not span the apertures in the coated region as a visual inspection showed that the pores were still exposed and not filled by the coating film. Accordingly, the application of the waterborne slurry to the mesh substrate did not result in an electrode having a conformal coating.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrode comprising:
a porous electrical current collector comprising a surface comprising a plurality of apertures;
a conformal coating present on at least a portion of the surface of the porous electrical current collector, the conformal coating comprising an electrochemically active material and an electrodepositable binder.

2. The electrode of claim 1, wherein the conformal coating is present as a film over the surface of the porous electrical current collector and within the apertures.

3. The electrode of claim 2, wherein the film present within the apertures comprises a continuous film that spans the apertures.

4. The electrode of claim 2, wherein the thickness of the conformal coating film within the apertures is within 50% of the thickness of the conformal coating film on the surface of the porous electrical current collector.

5. The electrode of claim 2, wherein the thickness of the conformal coating on the conductive material and within the apertures is from 0.5 microns to 1,000 microns.

6. The electrode of claim 1, wherein the apertures are uniformly distributed over the surface of the porous electrical current collector.

7. The electrode of claim 1, wherein the apertures have a diameter of 500 microns or less.

8. The electrode of claim 1, wherein the diameter of the apertures is no more than 10 times the thickness of the porous electrical current collector.

9. The electrode of claim 1, wherein the apertures have an average longest dimension of 1,000 microns or less.

10. The electrode of claim 1, wherein the conformal coating is present as a film over the surface of the porous electrical current collector and does not fill the apertures.

11. The electrode of claim 1, wherein the porous electrical current collector comprises aluminum, copper, steel, stainless steel, nickel, conductive carbon, a porous substrate with a conductive coating, or a conductive polymer.

12. The electrode of claim 1, wherein the electrodepositable binder comprises a pH-dependent rheology modifier.

13. The electrode of claim 1, wherein the electrodepositable binder comprises a fluoropolymer.

14. The electrode of claim 1, wherein the electrodepositable binder comprises a non-fluorinated organic film-forming polymer.

15. The electrode of claim 1, wherein the electrochemically active material comprises LiCoO₂, LiNiO₂, LiFePO₄, LiFeCoPO₄, LiCoPO₄, LiMnO₂, LiMn₂O₄, Li(NiMnCo)O₂, Li(NiCoAl)O₂, carbon-coated LiFePO₄, sulfur, LiO₂, FeF₂ and FeF₃, aluminum, SnCo, Fe₃O₄, or combinations thereof.

16. The electrode of claim 1, wherein the electrochemically active material comprises graphite, lithium titanate, lithium vanadium phosphate, silicon, silicon compounds, tin, tin compounds, sulfur, sulfur compounds, lithium metal, graphene, or a combination thereof.

17. The electrode of claim 1, wherein the conformal coating further comprises an electrically conductive agent.

18. The electrode of claim 1, wherein the electrodepositable binder comprises a film-forming polymer and a crosslinking agent.

19. The electrode of claim 1, wherein the electrode comprises a positive electrode.

20. The electrode of claim 1, wherein the electrode comprises a negative electrode.

21. An electrical storage device comprising:
(a) the electrode of any of claim 1;
(b) a counter-electrode; and
(c) an electrolyte.

22. The electrical storage device of claim 21, wherein the electrical storage device comprises a cell, a battery, a battery pack, a secondary battery, a capacitor, and/or a supercapacitor.

23-26. (canceled)

27. A method of preparing an electrode, the method comprising:
at least partially immersing a porous electrical current collector comprising a surface comprising a plurality of apertures into a bath comprising an electrodepositable coating composition comprising an electrochemically active material and an electrodepositable binder;
electrodepositing a conformal coating deposited from the electrodepositable coating onto a portion of the porous electrical current collector immersed in the bath, wherein the conformal coating comprises the electrochemically active material and the electrodepositable binder.
